(19) United States
(12) Patent Application Publication
(10) Pub. No.: US 2018/0343539 A1
(43) Pub. Date: Nov. 29, 2018

(54) SERVICE METRIC DATA MANAGEMENT

(71) Applicant: Metavallo, LLC, Albuquerque, NM (US)

(72) Inventors: Frank S. Oppenheim, Albuquerque, NM (US); Louis A. Rosa, Chesterfield, MO (US)

(21) Appl. No.: 15/986,869

(22) Filed: May 23, 2018

Related U.S. Application Data
(60) Provisional application No. 62/510,434, filed on May 24, 2017.

(51) Int. Cl. H04W 4/021; G06Q 50/12; H04L 12/24; H04L 29/08; H04W 4/80; G06Q 10/06

(52) U.S. Cl. CPC H04W 4/021; G06Q 50/12; H04L 41/5003; H04W 88/02; H04W 4/80; G06Q 10/06311; H04L 67/306

(57) ABSTRACT

A system for managing service metric data at a venue having customers and employees. The system can include a server device and a plurality of client devices. At least one of the client devices associated with a customer and at least one of the client devices associated with an employee. The server device and the plurality of client devices each including a processor and a computer readable storage medium. The computer readable storage medium of the server device can include instructions to cause the server device to receive a service request indicating a desired service for the customer and assign, using the server device, a service task to the employee by transmitting the service task via the network. The server can be configured to determine a response time for the service task, compare the response time to a predetermined service threshold time and generate service metric data.

### CROSS-REFERENCE TO RELATED APPLICATION

This application claims the benefit of U.S. Provisional Application No. 62/510,434, filed May 24, 2017, the disclosure of which is incorporated by reference herein.

### FIELD OF THE INVENTION

The present disclosure relates to systems for generation and analysis of metric data, and more specifically, to systems for generation and analysis of service industry metric data.

### BACKGROUND

Guest-facing service businesses such as, hotels, resorts, casinos, restaurants, night clubs/bars, and the like, often strive to differentiate themselves from competitors in their market space by promising exceptional service and convenience to their customers. As a result, many customers to these businesses have elevated expectations of service, including increased expectations for levels of attention, convenience, speed, and control. Successfully delivering on the promise of outstanding service not only attracts repeat business, but can also generate greater revenue and increased profitability.

As such, the service delivery challenge for guest-facing businesses is to attend quickly to customers when they require service, to fulfill customers' requests in a timely and efficient manner, and to gain customer input and insight.

Various methods, such as customer surveys, secret shopper programs, management reporting software products, and the like currently exist that attempt to address this challenge.

However, further tools to manage and to assess various guest-facing service delivery processes would be welcome to realize continuous improvement in service delivery.

### SUMMARY

One or more embodiments of the disclosure are directed to a system for service metric data management that provides an automated tool for improving transparency and accountability with regard to evaluating guest-facing service performance.

Described further below, in various embodiments the system possesses functionality for automatically generating and tracking a variety of service data/observations related to service applications including but not limited to: food, beverage, hotel, housekeeping, valet, bell check, resort, and slot service.

This functionality facilitates end-user management by granting management the ability to monitor, report and manage guest-facing business operations. As a result, the system provides management with tools for direct-line communications with customers and for accurately assessing employee performance. In certain embodiments the system further identifies activity for all end users based on the time of day, location within facility, service response time, spend, length of stay, trip frequency and other relevant system parameters. As a result, the system provides management end-users with an administrative “tool-kit” to automatically track information based on service request/order item activity.

In one or more embodiments, the service processes from initial receipt of the request/ordered item to ultimate disposition is tracked based upon management end user predetermined system parameters. This ‘tool kit” provides management with the ability to monitor, to report and to analyze service requests/ordered items providing end user management with actionable information/metrics. In addition, in various embodiments, the system provides management end users with real-time information to enable monitoring of each service request/ordered item as the process is occurring.

In one or more embodiments, the system collects and reports real-time information/metrics based on predetermined criteria established by management. Criteria can include, but not necessarily be limited to, a service-provider or employee's department, a manager's department, and a customer's loyalty status, spend, location, redemptions, promotions, contests, etc. The system also tracks and monitors information from inception to delivery with color-coded time markers or other similar alert method indicated to the employees so they can easily determine the real-time status of each request/order. The management end user can preset parameters to send out automated text messages or other system alerts when the information exceeds predetermined thresholds. The system also reports and enables end-user management to adjust, direct, reassign service requests/ordered items to manage the service request process thus enhancing service delivery toward the goal of guest service excellence. The process then utilizes logic to route observations, service times and other metrics to specific management to report in both real-time and post-fact basis.

As such, one or more embodiments are configured to generate various service metric data that corresponds to employee performance. For example, certain embodiments include a system that is configured to execute various automated processes that generate service metric data by monitoring and analyzing employee performance in response to service requests, from inception of the service request to its completion. Further, some embodiments are directed to a service metric data management system that provides integrated tools for measuring service performance and comparing the measured performance to known service standards to provide a toolkit to administer organization metrics, accountability, and continuous process improvement.

One or more embodiments provide real-time monitoring and tracking of all requests by identifying customers and their locations so that the entire process can be tracked. In this embodiment, customers get access to an easy, efficient, effective order/request system that provides these services. Various products in their particular forms provide functionality that facilitates payments, service alerts, checked item automated inventory functionality, and automated crowd management.

As a result, one or more embodiments provide benefits by addressing a critical hospitality industry issue—how to grow revenue and profits through service excellence.

Accordingly, one or more embodiments are directed to a system for managing service metric data at a venue having customers and employees. In some embodiments, the system includes a server device and a plurality of client devices, at least one of the plurality of client devices associated with a customer and communicatively connected with the server device via a network, and at least one of the plurality of client devices associated with an employee, the server device and the plurality of client devices each including a processor and a computer-readable storage medium.

In one or more embodiments, the computer-readable storage medium of the server device includes instructions executable by the processor of the server device to cause the server device to receive, from the at least one client device associated with the customer, a service request indicating a desired service for the customer. In various embodiments, the instructions cause the server device to assign a service task to the employee by transmitting the service task to the at least one client device associated with the employee via the network. In one or more embodiments the instructions cause the server device to determine, using the at least one client device, a response time for the service task. In various embodiments, the instructions cause the server device to compare the response time for the service task to a predetermined service threshold time and generate service metric data, at least using the comparison of the response time and the predetermined service threshold time.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a system for service metric data management, according to one or more embodiments of the present disclosure.

FIG. 2 depicts a computing node, according to one or more embodiments of the present disclosure.

FIG. 3 depicts a high level flowchart diagram of a process of service metric data management is depicted, according to one or more embodiments of the present disclosure.

FIG. 4 depicts a high-level diagram illustrating the overall Information Technology Topology of a system for service metric data management, according to one or more embodiments of the present disclosure.

FIG. 5 depicts a high-level diagram illustrating overall application security features, according to one or more embodiments of the present disclosure.

FIGS. 6A-6C depict high-level diagrams illustrating components of the system for service metric data management including components for information gathering capabilities, management reporting/analytics and customer contact administration capabilities.

FIG. 7 depicts a high-level diagram illustrating functionality of the customer smart device captive portal page of the system for service metric data management, according to one or more embodiments of the disclosure.

FIG. 8 depicts a high-level diagram illustrating the functionality of the customer smart device landing page of the system for service metric data management, according to one or more embodiments of the disclosure.

FIG. 9 depicts a process flow diagram illustrating the customer process of inputting customer information/insight using the system for service metric data management, according to one or more embodiments of the disclosure.

FIG. 10 depicts a process flow diagram illustrating the automated end user management process for the results of inputted customer information/insight, according to one or more embodiments of the disclosure.

FIG. 11 depicts a process flow diagram illustrating the automated end user management reporting/analytics resulting from customer information/insight, according to one or more embodiments of the disclosure.

FIG. 12 depicts a process flow diagram illustrating the automated end user management process for the results from real time service monitoring, according to one or more embodiments of the disclosure.

FIG. 13 depicts a process flow diagram illustrating the automated end user management reporting/analytics resulting from real time service monitoring, according to one or more embodiments of the disclosure.

FIG. 14 depicts a process flow diagram illustrating the Food and/or Beverage Service process/functionality of the system for service metric data management, according to one or more embodiments of the disclosure.

FIG. 15 depicts a process flow diagram illustrating the Hotel Services process/functionality of the system for service metric data management, according to one or more embodiments of the disclosure.

FIG. 16 depicts a process flow diagram illustrating the Free Wi-Fi® process/functionality of the system for service metric data management, according to one or more embodiments of the disclosure.

FIG. 17 depicts a process flow diagram illustrating the Hotel Housekeeping process/functionality of the system for service metric data management, according to one or more embodiments of the disclosure.

FIG. 18 depicts a process flow diagram illustrating the Bell Service process/functionality of the system for service metric data management, according to one or more embodiments of the disclosure.

FIG. 19 depicts a process flow diagram illustrating the Room Folio View/Check-Out process/functionality of the system for service metric data management, according to one or more embodiments of the disclosure.

FIG. 20 depicts a process flow diagram illustrating the Valet Car Drop Off process/functionality of the system for service metric data management, according to one or more embodiments of the disclosure.

FIG. 21 depicts a process flow diagram illustrating the Valet Car Pick-Up process/functionality of the system for service metric data management, according to one or more embodiments of the disclosure.

FIG. 22 depicts a process flow diagram illustrating the Slot Service process/functionality of the system for service metric data management, according to one or more embodiments of the disclosure.

FIG. 23 depicts a process flow diagram illustrating the Help-Service process/functionality of the system for service metric data management, according to one or more embodiments of the disclosure.

FIG. 24 depicts a process flow diagram illustrating the Checked Item Drop Off process/functionality of the system for service metric data management, according to one or more embodiments of the disclosure.

FIG. 25 depicts a process flow diagram illustrating the Checked Item Pick-Up process/functionality of the system for service metric data management, according to one or more embodiments of the disclosure.

FIG. 26 depicts a variety or service request buttons for a system for service metric data management, according to one or more embodiments of the disclosure.

While the embodiments of the disclosure are amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

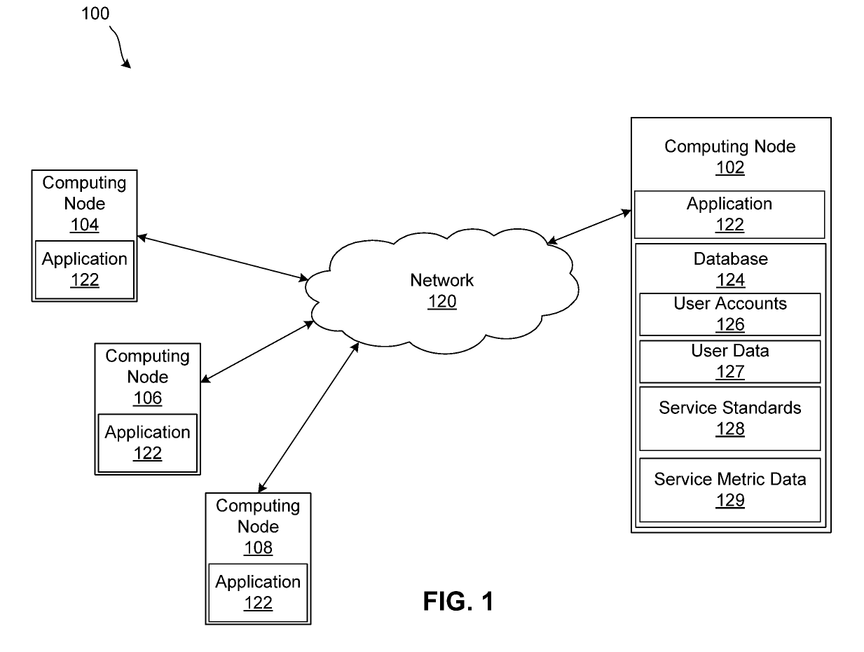

Referring to FIG. 1, a system 100 for service metric data management is depicted according to one or more embodiments of the present disclosure.

In various embodiments, the system 100 includes one or more computing nodes 102, 104, 106, 108. Computing nodes 102, 104, 106, 108, may be physical devices, usable by a consumer or other user, including processing elements and memory. In some embodiments, the computing nodes 102, 104, 106, 108, include, for example, a desktop computer, laptop computer, tablet device, smart phones, wearable computing device, or other suitable device. Described further below, in certain embodiments computing nodes 104, 106, 108 are each mobile devices, such as a laptop computer, tablet device, smart phone, wearable device, or other suitable portable device that is capable of being carried by a user. In such embodiments computing node 102 can alternatively be a non-mobile or non-portable device, such as a desktop computer, server, blade, or other suitable device. However, in certain embodiments all of the computing nodes 102, 104, 106, 108 could be mobile devices.

Seen in FIG. 1, computing nodes 102, 104, 106, 108, are interconnected via network 120, for communication. In one or more embodiments, the network 120 may be, for example, a local area network, a wide area network, a cloud computing environment, a public network (e.g. the internet), or other suitable network for communication between the computing nodes 102, 104, 106, 108. In various embodiments, the network is a “walled garden” restricted URL network environment. As used herein, the term walled garden refers to a network environment that controls the user's access to Web content and services. As such, in effect, the walled garden directs the user's navigation within particular areas, to allow access to a selection of material, or prevent access to other material.

In one or more embodiments, the system 100 outputs data and receives inputs to/from users via the computing nodes 102, 104, 106, 108. For example, the computing nodes 102, 104, 106, 108 may each include input/output devices, for example a display and/or touchscreen, for interfacing with a user via a graphical user interface (GUI) or other user interface.

In one or more embodiments, each of the computing nodes 102, 104, 106, 108 includes application 122 (“App”). In some embodiments, the App 122 is a program or “software” that is stored in memory accessible by computing nodes 102, 104, 106, 108 for execution on the computing nodes 102, 104, 106, 108. In one or more embodiments App 122 includes a set of instructions for execution by processing elements on one or more of the computing nodes 102, 104, 106, 108, for management of service metric data, described further below. In certain embodiments, App 122 is stored locally on some or all of the computing nodes 102-108. In some embodiments, App 122 is stored remotely, accessible to some or all of the computing nodes 102-108 via a network. For example, in certain embodiments App 122 is stored remotely on computing node 102 where users can access the application via the network 120 by connecting with computing node via a webpage. In such embodiments, the App 122 is a local instance on computing node 102 where users can access App 122 via an internet browser without downloading the Application 122 onto their device.

In some embodiments, when executing App 122, computing nodes 102, 104, 106, 108, are arranged in a client server architecture. For example, computing node 102 may be configured as a server with computing nodes 104, 106, and 108 arranged as clients. For example, depicted in FIG. 1, computing node 102 is a server including database 124, and computing nodes 104, 106, 108 are clients that use App 122 to communicate with the server to, for example, establish user accounts 26, generate user data 27, generate/receive service requests, and generate/submit service metric data to the computing node 102. In various embodiments, at least one of the computing nodes 104, 106, 108 are customer devices using App 122 to communicate with the server device 102 while at least one of the computing nodes 104, 106, 108 are employee devices using App 22 to communicate with the server device 102.

In some embodiments, computing node 102 is a server that uses App 122 that is dedicated to service metric data management and is configured to communicate with the client devices 102, 104, 106, 108 to, for example, receive service requests, manage/assign service tasks via the networked computing nodes, track the status of pending service requests, and generate service metrics for employees based on user generated information. In such embodiments, one or more of the client devices 104, 106, 108 could be client devices associated with a customer, while one or more other of the client devices 104, 106, 108 are associated with an employee end user. Described further below, in various embodiments, the system facilitates customer service requests by receiving customer requests via application 122, URL, or other source, and routing/transmitting the request to one or more employees via their corresponding computing node. Once the service is assigned, various metrics are tracked and can be presented to the employee/customer in real time. Color-coded indicators can be used to quickly convey employee performance. In certain embodiments the client devices associated with the customer are customer-owned devices. Further, in some embodiments, customer end users only interact with the system 100 via their own client devices. In certain embodiments, a supervisor could have one of the computing nodes and can track each of the pending service requests in real time/manage service assignments, etc.

In some embodiments, App 122 is a more generalized application, for example the App 122 could be configured as a general text messaging app that sends out automated text messages to employees and/or customers in response to various events. Described further below, in one or more embodiments the App 122 could be configured to send automated text messages to employees indicating the submission of a service request, indicating updates to existing requests, indicating whether the service request has exceeded a predetermined completion threshold, or other relevant information for an employee. In certain embodiments, the App 122 could be configured to send out messages indicating confirmation of the customer request, indicating the current status of the request, indicating the employee responsible for the request, or other relevant information for the customer.

In some embodiments, when executing App 122 the computing nodes 102, 104, 106, 108 are arranged in a peer-to-peer architecture, with computing nodes 102, 104, 106, 108 acting as both client and server.

In one or more embodiments, each of the computing nodes 104, 106, 108 may be used with App 122 to access a server (e.g., computing node 102) for access to known service standards 128, inputting user data 127, creating/modifying user accounts 126, or for other purposes.

In one or more embodiments, the App 122 includes a set of instructions for service metric data management. As such, in certain embodiments, the set of instructions are executable on the computing nodes 102-108 to perform various tasks or commands as described herein. For example, in one or more embodiments, the system 100 allows a customer to access the network 120 via the App 122 to request a business product or service. In various embodiments, the service request is submitted to the server device 102 via network 120, which then confirms the request and uses logic to assign the request to an employee client device or other computing node in the system 100. In some embodiments, the service request is submitted via a GUI provided by the App 122 that is accessible on the customer's client device. For example, in certain embodiments, the App 122 presents a listing, or menu, of products and/or services to a customer to facilitate the ordering of products and/or services.

In various embodiments the system 100 notifies an employee of the assigned service request via one or more of the computing nodes 102-108 and indicates the nature of the service request, location of the customer, and other relevant information to the employee. In addition, in various embodiments, the system 100, via the one or more computing nodes 102-108, monitors the status of the assigned tasks for each employee from inception to fulfillment of the service request.

For example, in various embodiments, the system 100 maintains a status of all pending service requests and tracks the time from confirmation of the request to the fulfillment of the request for each employee. In one or more embodiments, the system is configured to compare the tracked time with preset or known parameters for service standards. In various embodiments the service standards are preset delivery time or service time thresholds that indicate an acceptable time for completion of the service request. For example, the system could be configured to have a service time threshold for response to service request for a drink order of three minutes. As such, in certain embodiments the system tracks the order from inception to completion and compares the tracked time with the three minute threshold. In various embodiments, the system 100 could use multiple thresholds indicating varying levels of acceptable performance. For example, the system could employ three thresholds corresponding to “excellent” “acceptable” and “unacceptable” performance standards. In certain embodiments, the system 100 uses color-coded time markers to indicate the status of the request to an employee for ease of determining the real time status of the order.

In certain embodiments, the system 100 generates service metric data 129 from this information. As used herein, service metric data 129 refers to data or other information generated regarding employee performance in response to customer generated service requests. For example, in various embodiments, service metric data 129 includes response times for fulfillment of service requests, comparison of the response times with service standards 128, customer reviews or ratings, customer complaints generated, and other indicators of employee performance.

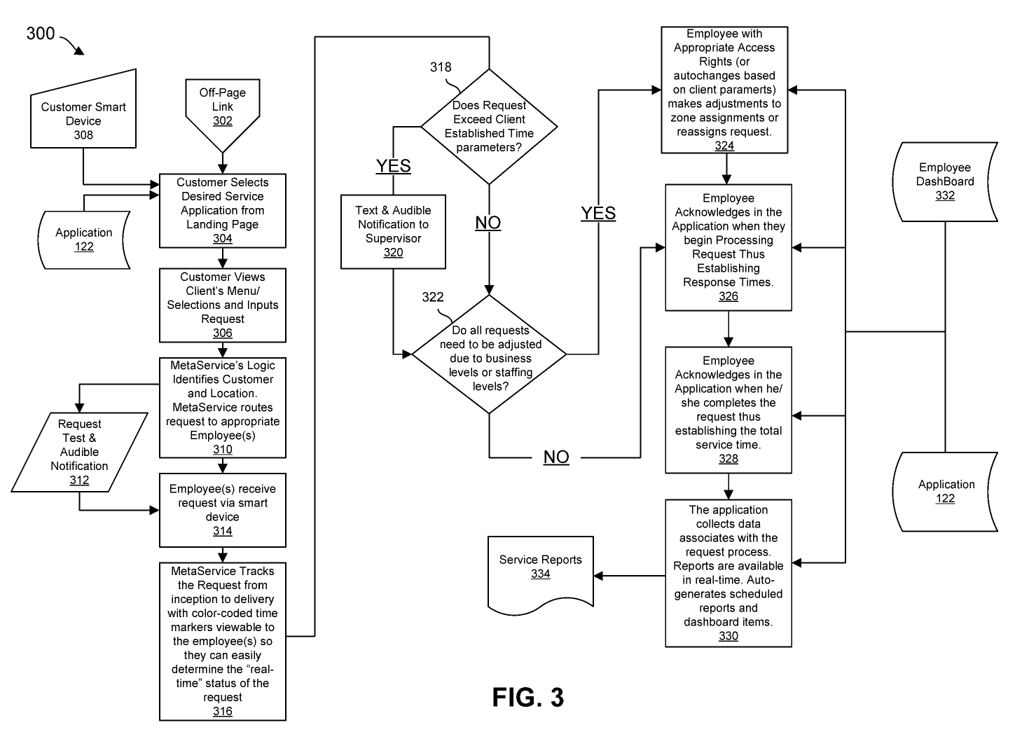

In addition, in various embodiments, App 122 includes instructions to execute the flowchart diagrams and descriptions of the flowchart diagrams as described with reference to FIGS. 3-26 below.

In some embodiments, the database 124 includes user accounts 126, user data 127, service standard information 128, and service metric data 129.

When executing App 122, one or more of the computing nodes 102, 104, 106, 108 may be configured to communicate with a server to create one or more user accounts. For example, depicted in FIG. 1, computing node 102 is a server including database 124, and computing nodes 104, 106, 108 communicate via network 120 to establish user accounts 126. Computing nodes 104, 106, 108 may use App 122 by logging into user accounts 126 and communicating with the server.

The user accounts 126 may include an administrative account and one or more client accounts. In some embodiments, the administrative account may be a user account including privileges for configuring the system 100. For example, in some embodiments the administrative account may create or modify user accounts 126. In various embodiments the administrator also has the ability to set and change the routing of the order through a dashboard with level permission access as business and staffing levels dictate. These dashboard routing changes can be completed in real time or preset in anticipation of business level fluctuations. The process automatically collects the data associated with the requested delivery and auto-generates scheduled reports disseminating this data.

In one or more embodiments, the user data 127 includes user information including, the user's name, date of birth, email address, phone number, and notification preferences. In some embodiments, the user data 127 includes job information, such as, for example, the user's job, department and position. In certain embodiments, and described further below, the user data 127 includes average worth, average visitation length of stay, and loyalty tier status, and other relevant metric data.

In certain embodiments, App 122 is configured to use the user data 127 to generate a service metric profile for a user. In various embodiments, the service metric profile will include data or other information generated regarding employee performance in response to customer-generated service requests. For example, in various embodiments, service metric data 129 includes response times for fulfillment of service requests, comparison of the response times with service standards 128, customer reviews or ratings, customer complaints generated, and other indicators of employee performance.

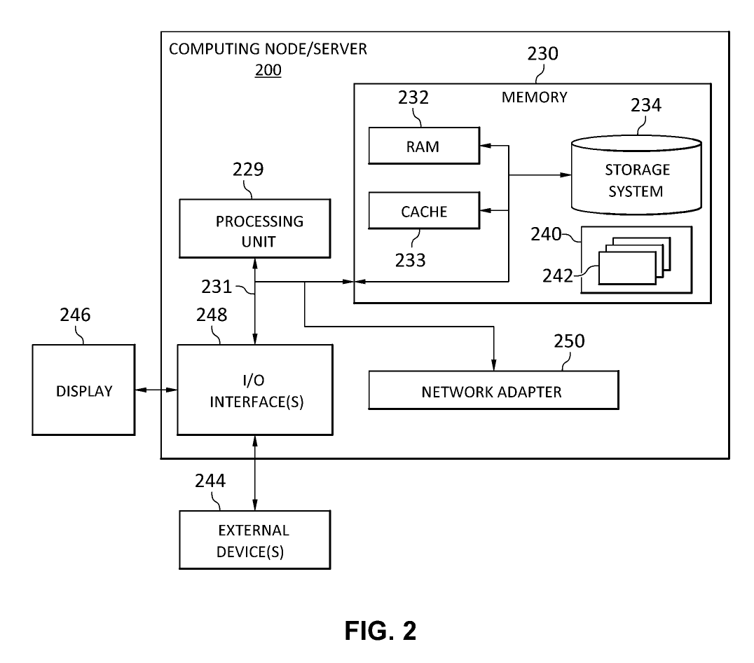

Referring now to FIG. 2, a block diagram of a computing node 200 for service metric data management is depicted, according to one or more embodiments of the disclosure. Computing node 200 is only one example of a suitable system and is not intended to suggest any limitation as to the scope of use or functionality of the embodiments described herein. Regardless, computing node 200 is capable of being implemented and/or performing any of the functionality set forth as described herein.

Computing node/server may be operational with numerous other general purpose or special purpose computing system environments or configurations. Examples of well-known computing systems, environments, and/or configurations that may be suitable for use with computing node/server 200 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed computing environments that include any of the above systems or devices, and the like.

Computing node/server 200 may be described in the general context of computer system, including executable instructions, such as program modules, being executed by a computer system. Generally, program modules may include routines, programs, objects, components, logic, data structures, and so on that perform particular tasks or implement particular abstract data types. Computing node/server 200 may be practiced in distributed computing environments where tasks are performed by remote processing devices that are linked through a network. In a distributed computing environment, program modules may be located in both local and remote computer system storage media including memory storage devices.

As shown in FIG. 2, computing node/server 200 is shown in the form of a general-purpose computing device. The components of computing node/server 100 may include, but are not limited to, one or more processors or processing units 229, a system memory 230, and a bus 231 that couples various system components including system memory 230 to processor 229.

Bus 231 represents one or more of any of several types of bus structures, including a memory bus or memory controller, a peripheral bus, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing node/server 200 typically includes a variety of computer readable media. Such media may be any available media that is accessible by computing node/server 200, and it includes both volatile and non-volatile media, removable and non-removable media.

System memory 230 can include computer readable media in the form of volatile memory, such as random access memory (RAM) 232 and/or cache memory 233. Computing node/server 200 may further include other removable/non-removable, volatile/non-volatile computer storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk, and an optical disk drive for reading from or writing to a removable, non-volatile optical disk such as a CD-ROM, DVD-ROM or other optical media can be provided. In such instances, each can be connected to bus 231 by one or more data media interfaces. As will be further depicted and described below, memory 230 may include at least one program product having a set (e.g., at least one) of program modules that are configured to carry out the functions of embodiments of the disclosure.

Program/utility 240, having a set (at least one) of program modules 242, may be stored in memory 230 by way of example, and not limitation, as well as an operating system, one or more application programs, other program modules, and program data. Each of the operating system, one or more application programs, other program modules, and program data or some combination thereof, may include an implementation of a networking environment. Program modules 242 generally carry out the functions and/or methodologies of one or more of the embodiments described herein.

Computing node/server 200 may also communicate with one or more external devices 244 such as a keyboard, a pointing device, a display 246, etc.; one or more devices that enable a user to interact with computing node/server 200; and/or any devices (e.g., network card, modem, etc.) that enable computing node/server 200 to communicate with one or more other computing devices. Such communication can occur via an Input/Output (I/O) interface 248. Still yet, computing node/server 200 can communicate with one or more networks such as a local area network (LAN), a general wide area network (WAN), and/or a public network (e.g., the Internet) via network adapter 250. As depicted, network adapter 250 communicates with the other components of computing node/server 200 via bus 231. It should be understood that although not shown, other hardware and/or software components could be used in conjunction with computing node/server 200. Examples, include, but are not limited to: microcode, device drivers, redundant processing units, external disk drive arrays, RAID systems, tape drives, and data archival storage systems, etc.

Referring to FIG. 3, a high-level flowchart diagram of a process 300 for service metric data management is depicted, according to one or more embodiments. In one or more embodiments, at operations 302, 304, and 306, the process 300 includes accessing, via an off-page link, a customer landing page using a customer smart device 308 and or an Application 122, as described above with reference to FIGS. 1-2. In various embodiments customer smart device 308 is a computing node such as computing node 104, 106, 108, described above with reference to FIGS. 1-2.

In various embodiments the customer landing page allows a customer to request a business product or service. In various embodiments, the service request is submitted to a server device via a network walled garden network. In various embodiments, the customer landing page displays various menus/selections for a customer and is configured to receive the serve request and forward the request to a server device.

In various embodiments, at operations 310, 312, and 314, the server device can confirm the request and uses various application logic to assign the request to an employee client device. In various embodiments the system notifies an employee of the assigned service request and indicates the nature of the service request, location of the customer, and other relevant information to the employee.

In addition, in various embodiments, at operation 316, the system monitors the status of the assigned tasks for each employee from inception to fulfillment of the service request. For example, in various embodiments the system maintains a status of all pending service requests and tracks the time from confirmation of the request to the fulfillment of the request for each employee. In one or more embodiments, the system is configured to compare the tracked time with preset or known parameters for service standards. In various embodiments the service standards are preset delivery time or service time thresholds that indicate an acceptable time for completion of the service request. For example, the system could be configured to have a service time threshold for response to service request for a drink order of three minutes, however any amount of time could be set for the service time threshold. As such, in certain embodiments the system tracks the order from inception to completion and compares the tracked time with the three minute threshold. In certain embodiments, in decision block 318, if the response time exceeds the threshold, the system notifies a supervisor of the delay at operation 320. Otherwise, decision block 318 proceeds to decision block 322 without notifying a supervisor.

In various embodiments, the system could use multiple thresholds indicating varying levels of acceptable performance. For example, the system could employ a plurality of thresholds, which in an embodiment may comprise three thresholds, corresponding to “excellent” “acceptable” and “unacceptable” performance standards. In certain embodiments, the system uses color-coded time markers to indicate the status of the request to an employee for ease of determining the real time status of the order.

In certain embodiments, at decision block 322, the system can set or adjust standards or thresholds for service requests. In some embodiments, such adjustment can be based on business levels or staffing levels. For example, in some instances performance thresholds could be lengthened in instances where staffing is insufficient, when the quantity of service requests is exceeds some threshold, or based on other factors. In certain embodiments, the thresholds for service requests could be adjusted based on user data for a customer. For example, in some embodiments, the system could set lower or higher service standard for a customer request based on, for example, the customer's loyalty tier status. As such, the system could set a corresponding longer or shorter service threshold time for response to a service request from a user.

In some embodiments, instead of adjusting service standards or thresholds for service requests, the system can set or adjust the employees assigned to the request or the general assignment for an employee. For example, in some embodiments the system could reassign some employees from one area with relatively fewer service requests to another area with a greater number of service requests.

As such, in one or more embodiments, if standards or thresholds for service requests need to be adjusted, then process 300 proceeds to operation 324, where service standards can be adjusted, as described above. In various embodiments such adjustments can be made manually, by an employee with appropriate access rights and/or automatically, where the system is configured to make one or more automatic adjustments based on preset client parameters. In one or more embodiments, the process 300 then proceeds to operation 326.

Otherwise, if at decision block 322, no adjustment is needed, the process 300 skips operation 324 and proceeds directly to operation 326. In various embodiments, at operations 326, and 328 the process 300 includes receiving acknowledgement from an assigned employee when they begin processing a service request and when the service request is completed. In various embodiments, by receiving an acknowledgement that the employee has begun to process a service request, the system can begin to track various service metrics, such as for example, the response time of the employee from acceptance until completion of the service request. As such, in operation 328, when the employee completes the service request and sends an acknowledgement of service completion, the system can record the total service time for evaluation/tracking of employee performance.

In various embodiments, at operation 330, the system can generate service metric data or service reports 334 from this information. For example, in various embodiments, service metric data includes response times for fulfillment of service requests, comparison of the response times with service standards, customer reviews or ratings, customer complaints generated, and other indicators of employee performance.

In certain embodiments, for at least operations 324, 326, 328, and 330, an employee interacts with the system via an employee device that provides access to application 112 via an employee dashboard 332 or other interface that allows for input to the system.

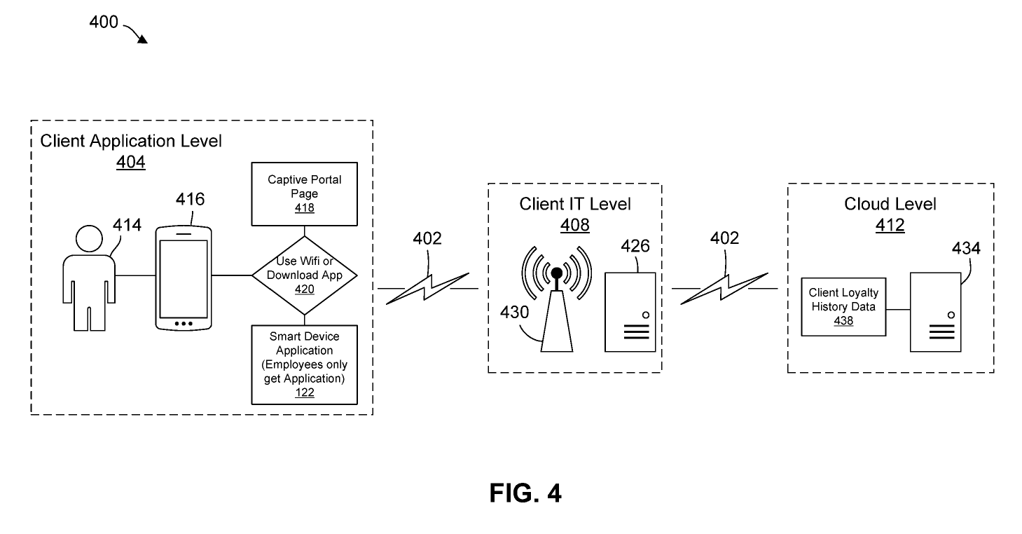

Referring to FIG. 4, a high-level diagram of the overall information technology topology of a system 400 for service metric data management is depicted, according to one or more embodiments.

In one or more embodiments the system 400 is made up from a plurality of system levels that that are in communication with one another via one or more wired or wireless connections 402. In certain embodiments these levels include a client application level 404, a client IT level 408, and a cloud level 412.

In various embodiments, the client application level 404 includes the various end users 414 of the system 400 who interact with the system 400 via a client device 416 which, as described above with reference to FIG. 1, can be a mobile device such as a smart phone, tablet, laptop, or other computing device. In various embodiments, as described above, the end users 414 interact with the system by accessing a captive portal page 418 or via an application 122 that can be downloaded and stored on the user's client device 416. In various embodiments, where the user 414 is first interacting with the system 400 the system will direct them to a welcome page where the system 400 will give the end user 414 an option at decision block 420 as to whether to download the application 122 or to access the captive portal page 418. In instances where the end user 414 is an employee, the system 400 can be configured to automatically direct the end user 414 to download the application 122.

In various embodiments, the captive Portal Page 418 is a “landing” web page, presented by a service or device operating at the client IT level 408 or cloud level 412 and shown to users before they gain broader access to URL or http-based Internet services. Often used to present a landing or log-in page, the portal intercepts observed packets until such time as the user is authorized to launch browser sessions. After being redirected to a web page which requires authentication, acceptance of EULA/acceptable use policies or other valid credentials that the host and user agree to, the user is granted conditional Internet access. Captive portals are used for a broad range of mobile and pedestrian broadband services including commercially provided Wi-Fi used to provide access to enterprise wired networks (such as retail, hotel rooms, business centers).

For example, in various embodiments, the system 400 includes automated software that connect, at the client level, to the system 400 through smart devices within a Wi-Fi “walled garden” restricted URL network environment. The system 400 enables identification of users 414 through various methods including but not limited to user input including employee password; customer “opt in” through captive portal page process; downloadable smart device application; or, automatic system identification through end user smart device hardware signatures. The system can also provide limited system applications to customer end users who choose not to opt in or download a smart device application.

In one or more embodiments, the client IT level 408 includes a local server 426 and a wireless access point 430 for facilitating local communication with the various end users 416 of the client application level 404. As described above with reference to FIG. 1, in various embodiments the client IT level 408 facilitates the creation of a network between each of the client devices 416 and the server 426 of the system 400. In such embodiments the client IT level 408 facilitates the creation of the walled garden network environment.

In various embodiments the cloud level 412 includes a cloud server 434 that is communicatively connected with the client IT level 408. In one or more embodiments the cloud level 412 includes the higher level infrastructure for operation of the system 400. For example, various embodiments the cloud server 434 can function for storage of various user data or other information. For example, depicted FIG. 4, cloud server 434 stores various client loyalty data 438, and other user data. In such embodiments, the cloud server 434 can store large amounts of data, alieving the server 426 of the client IT level 408 from the need of possessing large quantity of data storage. Similarly, in some embodiments, the cloud serve 434 can provide processing, memory, and other computing functions for operating the application 122 and system. For example, in various embodiments the cloud server 434 can provide access to various hardware resources for smooth/uninterrupted operation of the application 112.

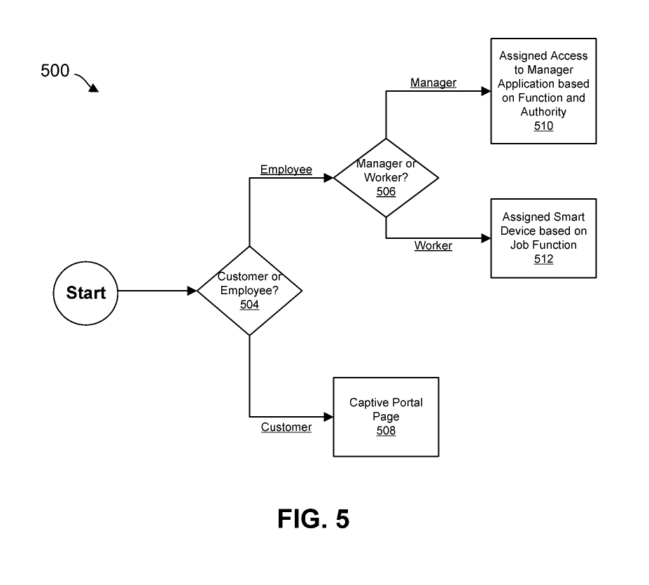

Referring to FIG. 5, a high-level diagram of a process 500 illustrating overall application security features is depicted, according to one or more embodiments of the disclosure. In one or more embodiments, the process 500 begins at decision blocks 504 and 506 where the process 500 includes identifying/categorizing end users and providing system authorization and functionality based on that identity/categorization. In certain embodiments end users can be placed in at least one category, such categories including but not limited to customer, employee, manager, department, and location.

For example, depicted in process 500, at decision block 504 the system can determine whether the end user is a customer or employee. In certain embodiments, if the end user is identified as a customer, the system utilizes logic to direct the end user to access to a customer captive portal page, at operation 508, where the customer is granted particular system authorization to request various services, input user data, and to perform various other functions. In some embodiments, if the end user is identified as an employee then the process 500 proceeds to decision block 506 where the system can determine whether the end user is a manager or other worker. In certain embodiments, if the end user is identified as a manager, the process 500 proceeds to operation 510 where the system can assign manager authorization/access to the end user. In some embodiments, if the end user is identified as a worker, the process 500 proceeds to operation 512 where the system can grant authorization/access to the worker based on the worker's job or access requirements.

In certain embodiments the system can utilize logic to route service requests and customer insight in terms of observations, requests, service times and other actionable metrics to specific management to report in both real-time and post-fact basis.

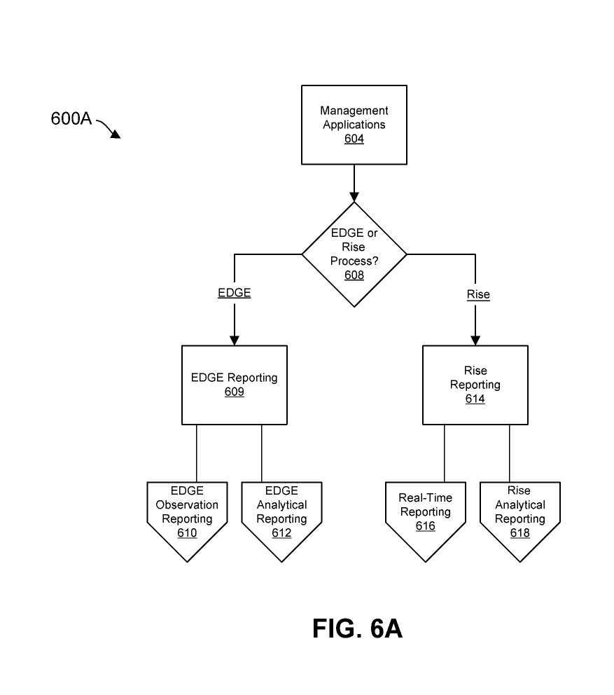

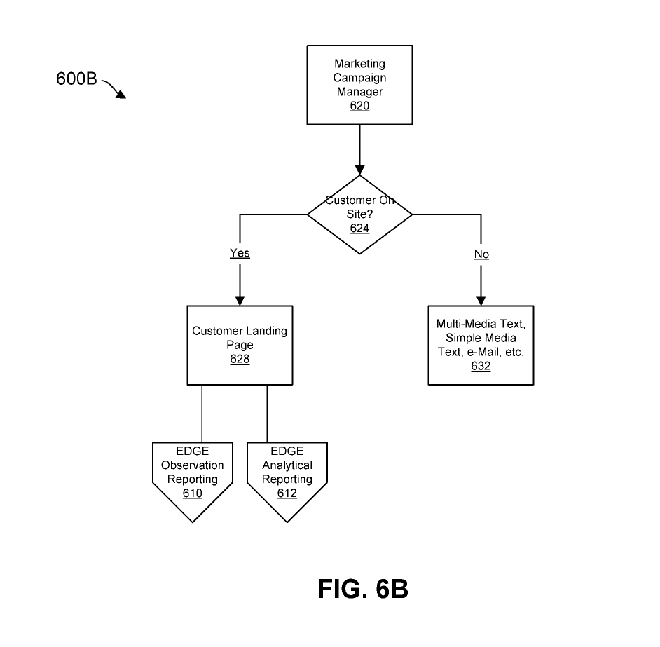

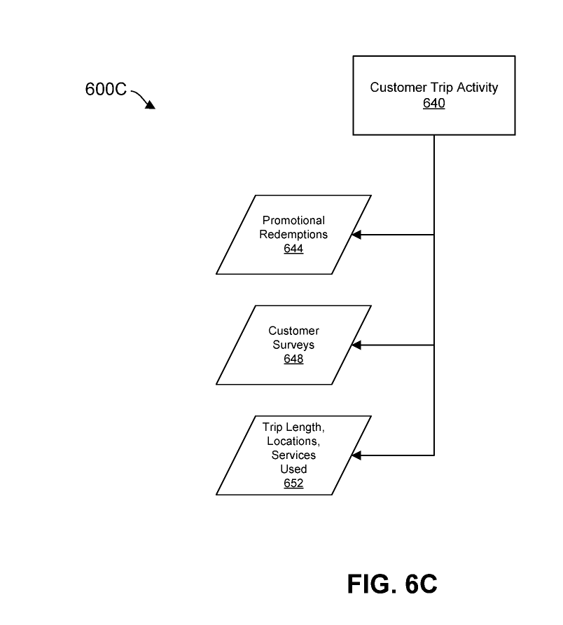

Referring to FIGS. 6A, 6B, and 6C, high-level diagrams illustrating processes 600A, 600B, and 600C for service metric data management including components for information gathering capabilities, management reporting/analytics and customer contact administration capabilities are depicted, according to one or more embodiments of the disclosure.

Referring to FIG. 6A, in one or more embodiments the system provides guest service/customer insight tools to customer facing businesses. The system provides end-user management with a software, technology, and/or service culture ecosystem that addresses critical guest-facing industry processes designed to provide timely information to management end users to drive business efficiency, effectiveness, and continuous improvement. In various embodiments at operation 604, management end users can access these insight tools to determine various customer-based or system-based feedback on employee performance. In such embodiments, at decision block 608, if the management end user desires to view various customer based feedback, then the process 600A proceeds to operation 609, where the management end user can review various customer driven analytical and observational reporting 610, 612.

If the management end user desires to view various system tracked employee metrics, then the process 600A proceeds to operation 614, where the management end user can review various system based real-time and analytical reporting 616, 618.

Referring to FIG. 6B, in one or more embodiments the system enables management end users to manage/generate various customer generated metrics/service feedback, and to generate customer communications in the form of e-mail, text messages and other electronic manners. For example, in one or more embodiments, at operation 620, management end users can access these tools to determine various customer based or system based feedback or initiate various customer communications.

In such embodiments, at decision block 624 if the customer is on site at a property, then the process 600B proceeds to operation 628, where the management end user can review various customer driven analytical and observational reporting 610, 612. If the management end user desires initiate customer communications, then the process 600B proceeds to operation 614, where the management end user can review various system-based real-time and analytical reporting 616, 618. If, at decision block 624—the customer is not on-site at a property, then the process 600B proceeds to operation 632, where the management initiate various customer communications, as described above.

Referring to FIG. 6C in various embodiments the system tracks customer activity 640 including requests, orders, customer insight, offers issued/redeemed, promotional activity, and contests. Pertinent detail regarding this activity is maintained by the system including time, date, location, service times, spend, etc. For example, depicted in process 600C the system can track promotional redemptions 644, customer surveys 648, trip length, locations, and services used 652.

In certain embodiments the system further identifies or categorizes customers based on various statuses including customer, customer loyalty status, visitation frequency, average length of stay, average spend, time of day, facility location, and other relevant system parameters. As described above, in various embodiments, the user data 127 (FIG. 1) includes information on the various customer statuses as described.

In various embodiments the system includes comprehensive integrated tools to measure and report service standards; to measure and report various service time points at customer service touch-points; to provide a human resources toolkit to administer customer service and employee engagement through organizational metrics, accountability, and continuous process improvement techniques.

As described, in one or more embodiments the system tracks and monitors information from inception to delivery with color-coded time markers or other similar alert methods indicated to the employees so they can easily determine the real-time status of the information. The management end user can preset parameters to send out automated text messages or other system alerts when the information exceeds predetermined thresholds.

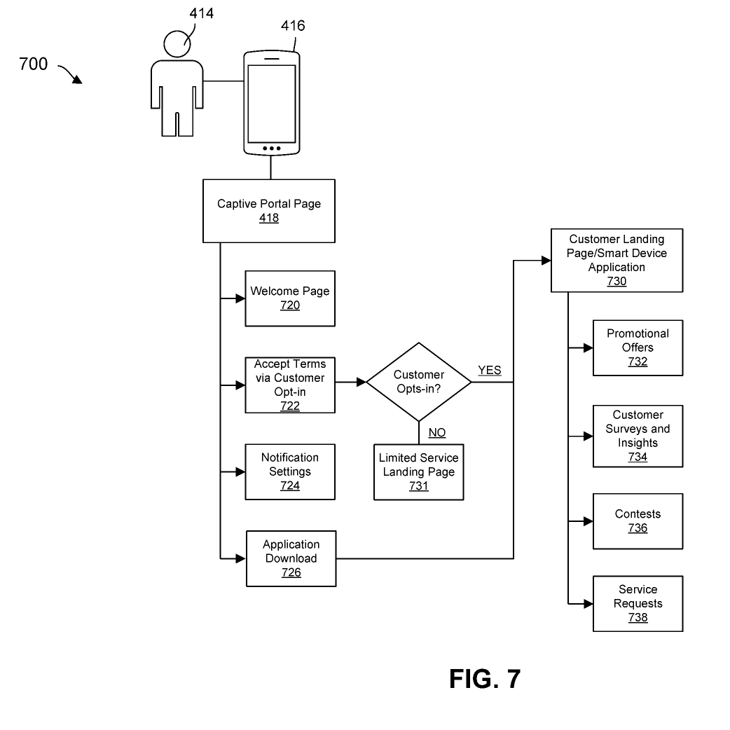

Referring to FIG. 7 a high-level diagram of a process 700 illustrating functionality of the customer smart device captive portal page 418 and application 122 of the system for service metric data management is depicted, according to one or more embodiments of the disclosure.

In various embodiments, as described above with reference to FIGS. 4 and 5, when an end user 414 accesses the system for service metric data management the system first directs the user to a captive portal page 418. As shown in operations 720, 722, 724, 726, when the end user 414 accesses the captive portal page 418, the page 418 can generally include an end user 414 welcome page, a customer opt-in page where the end user 414 is able to agree or decline various terms of usage, a settings page where the end user 414 is able to configure various settings options, for example notification settings or other options, and an application 122 download page.

Referring specifically to operation 722, as described above, in one or more embodiments when an end user 414 accesses the captive portal page 418, the system can initially enable identification of users 414 through various methods including but not limited to user input including employee password; customer “opt in” through operation 724 of the captive portal page process 700; customer download of a smart device application through operation 726; or, automatic system identification through end user smart device hardware signatures. In one or more embodiments, the systems' customer “opt in” and customer downloadable application processes satisfy regulatory requirements of such processes. Specifically, in certain embodiments end users 414 will need to provide text number response and/or other required identification to the system. In certain embodiments the system also can identify end users and provide system authorization and functionality based on that identity.

As such, if at decision block 728, the end user opts-in or accepts the terms of system usage, in various embodiments the process 700 proceeds to operation 730 where the end user can access a customer landing page. If the end user rejects or declines opt-in, in various embodiments, the process 700 proceeds to operation 731. In such embodiments, the system can provides a variety of limited system applications to customer end users who choose not to opt in or download a smart device application.

At operation 730, when a user accepts the opt-in terms, or accesses the functionality of the system through the application 122, the end user is directed to a customer landing page. Depicted in operations 732, 734, 736, 738, in various embodiments the customer landing page can include promotional offers, customer surveys, contest, and described further below, functionality for requesting various services.

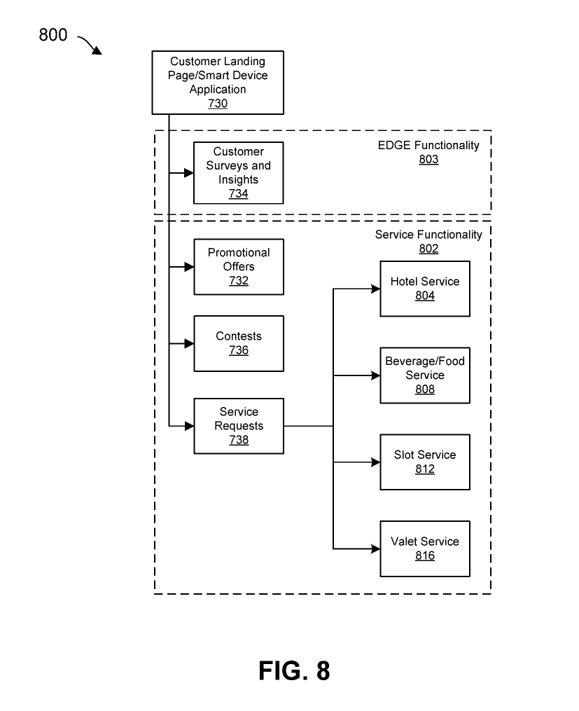

Referring to FIG. 8 a high-level diagram illustrating a process 800 for functionality of the customer smart device landing page of the system for service metric data management, according to one or more embodiments of the disclosure. As described above with reference to FIG. 7, when an end user 414 accesses the functionality of the system through the application 122, the end user is directed to a customer landing page 730. Depicted in operations 732, 734, 736, 738, in various embodiments the customer landing page can include promotional offers, customer surveys, contest, and described further below, functionality for requesting various services. In certain embodiments these selections are categorized between two different types of customer end user selections. For example, in various embodiments, operations 732, 736, 738 are categorized as service functionality offerings 802, while operation 734 is categorized as customer EDGE (Exceptional Delivery of Guest Experience) functionality 803. In various embodiments, the service functionality offerings 802 include selections that lead the customer end user to various service requests, and include various marketing functionality such as promotional offerings and contest offerings. For example, described further below, in various embodiments the customer service request functionality is capable of a variety of service functions. For example, as depicted in operations 804, 808, 812, and 816, in various embodiments the system is capable of hotel service, food/beverage service, slot service, and valet service. However a wide variety of different service offerings could be employed.

In certain embodiments, the system displays customer landing pages' functionality is determined by end user managers. In various embodiments the system provides an easily customized landing page presented to customers as they connect to the Internet. The system further identifies customers based on various statuses including customer, customer loyalty status, customer visitation frequency, average length of stay, average spend, time of day, location within facility, and other relevant system parameters. Once a customer is identified as being “on site”, end user management can initiate communication with that customer based on management's intent.

In various embodiments, the EDGE functionality offerings 803 include selections that provide customer based feedback and/or employee-to-employee based feedback for generating system insight into service metrics/performance. In such embodiments customer EDGE functionality 803 includes operations 734 of inputting customer information/insight using the system for service metric data management.

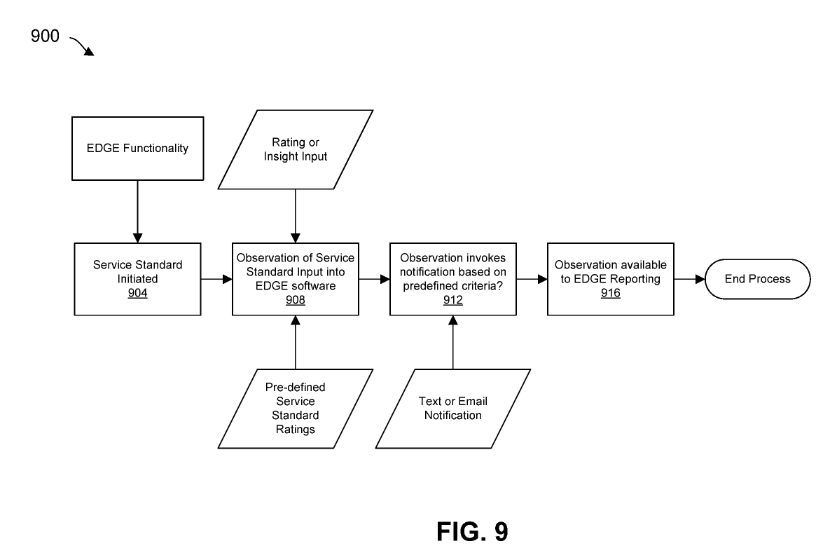

For instance, referring to FIG. 9, a process 900 flow diagram illustrating the customer process of inputting customer information/insight using the system for service metric data management is depicted, according to one or more embodiments of the disclosure.

In various embodiments, at operations 904, 908, 912, and 916, the system collects customer facing service observations from both end user customers and end user managers based on predetermined criteria established by management. Criteria can include, but is not limited to, employee's department, manager's department, and customer's loyalty status. Alternatively, customer insight can be obtained for non-service criteria or attributes as management so decides. These service observations are entered in the system through end user smart devices. The system also can automatically send system notification to management based on the results of the observations. Such notifications occur based on manager's predetermined criteria.

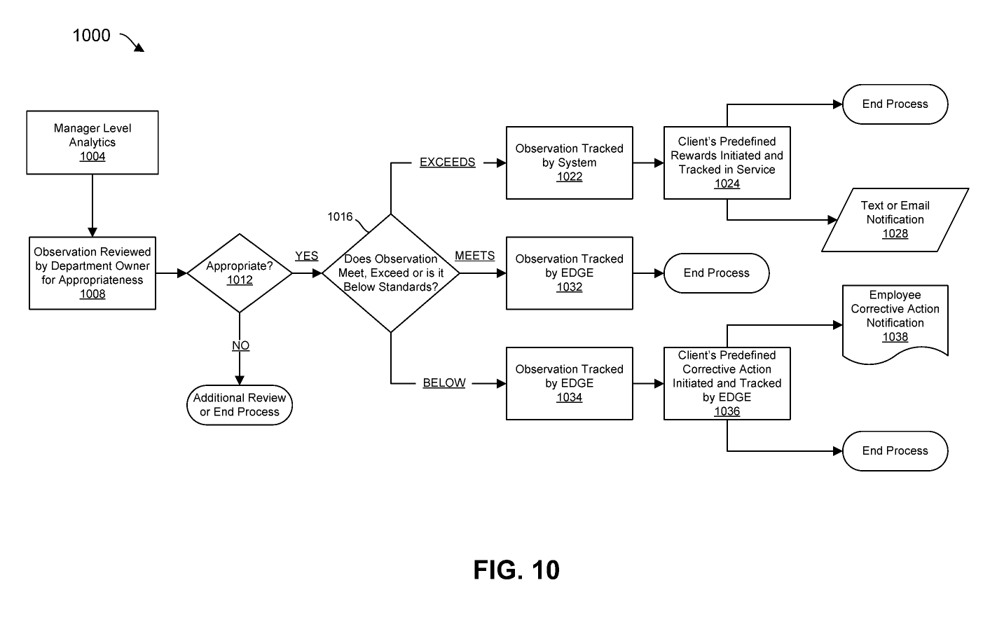

Referring to FIG. 10, a process 1000 for providing an administration “tool kit” of service/customer insight information is depicted, according to one or more embodiments. In various embodiments the process 1000 provides management end-users with a “tool-kit” to automatically track service performance information and provide real-time feedback to employees. In such embodiments the process 1000 provides management with the ability to communicate and/or report service results/customer insight, to provide employee engagement processes and to provide other metrics reporting to end user management.

Referring to operations 1004 and 1008, in various embodiments the process 1000 includes accessing a plurality of manager level analytics/statistics tracked by the system for review by manager level employees. In one or more embodiments, the initial receipt of the service performance observations/information to administering of results to employee is compared with one or more predetermined parameters or thresholds to determine wither the observed parameters/statistics are appropriate. For example, depicted in decision blocks 1012 and 1016 if the observed performance statistics satisfy an initial performance threshold, then at decision block 1016, the system compares the observed performance statistics to three additional performance thresholds. In various embodiments these additional thresholds include a “below expectations” threshold, a “meets expectations” threshold, and an “exceeds expectations” threshold.

In such embodiments, if the service statistics exceed performance thresholds, then, at operations 1020, 1022, 1024, the system tracks and retains all observations and initiates a predefined employee reward. In such embodiments, the employee can be notified of the reward via a text or email notification 1028 and the process then ends. In various embodiments, if the service statistics meet performance thresholds, then, at operation 1032, the system tracks and retains all observations and the process 1000 then ends. In various embodiments, if the service statistics are below performance thresholds, then, at operations 1034, 1036, 1038, the system tracks and retains all observations and initiates a predefined employee corrective action. In such embodiments, the employee can be notified of the corrective action via a text or email notification 1038 and the process then ends.

In various embodiments the system retains all observations as part of the systems historical file so status of all employees is tracked for reporting purposes. The various types of observations including customer and management are both separately reported but also available to management end user for comparison to each other to gain important management information towards the goal of continuous improvement. Further, the system tracks all observations to provide management with tools to determine who is being observed and who is making the observations. The process then utilizes logic to route observations, service times and other metrics to specific management to report in both real-time and post-fact basis.

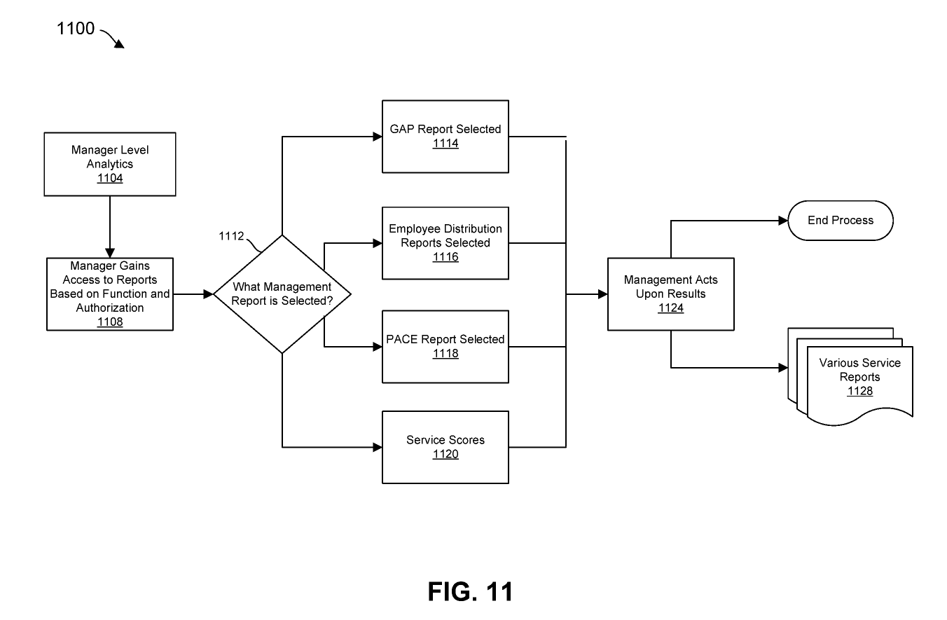

Referring to FIG. 11, a process 1100 for providing a management tracking and administration “tool kit” of service/customer insight information is depicted, according to one or more embodiments.

For example, referring to operation 1104, the system can access a plurality of manager level analytics/statistics that have been tracked and recorded for review by various manager level employees. For example, as described above with reference to FIG. 10, in various embodiments the system retains all data/observations related employee performance as part of the system's historical file. As such, the status of all employees is tracked for reporting purposes.

In such embodiments, in operation 1108 and decision block 1112, a manager can choose between various types of observation reports for manager review. For example, as shown in operations 1114, 1116, 1118, 1120, these manager reports include various types of observations including customer and management data that are both separately categorized and reported but also available to management end user for comparison to each other to gain important management information towards the goal of continuous improvement. In one type of report, the system tracks all observations to provide management with tools to determine what employee, and accordingly department, is being observed and who is doing the observations. This report provides important accountability information that drives customer service and employee engagement. The process also compiles service scores as it pertains to, but not limited to date, employee, department, observer, etc. In another type of report, the process also compiles other actionable customer insight information to dissemination to end user management personnel. The process utilizes logic to route observations, customer insight and other metrics to specific end user management to report in a post-fact basis. In various embodiments, in operation 1124, once the reports have been accessed by the manager the manager can act or make various decisions for adjusting service standards, staffing, or other decisions. In such embodiments decisions can be made using a variety of service reports 1128 that are generated by the system for the selected management report.

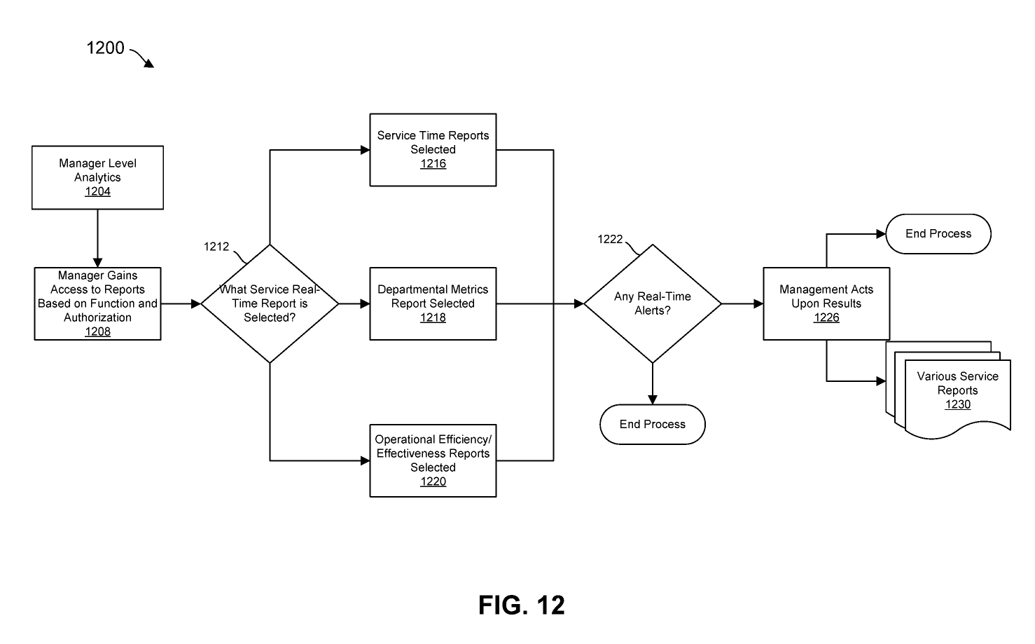

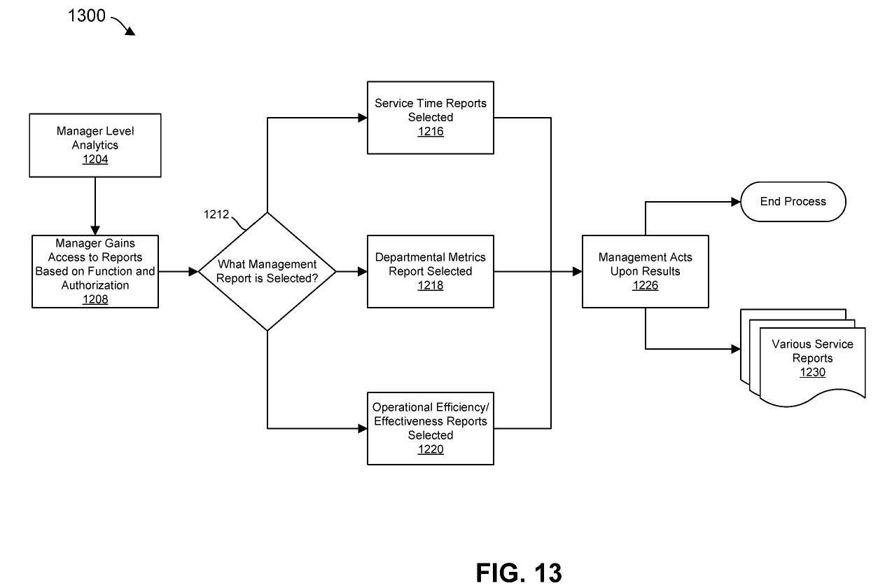

Referring to FIGS. 12-13, a process 1200 and 1300 flow diagram illustrating the automated end user management process for the results from real time service monitoring is depicted, according to one or more embodiments of the disclosure.

For example, referring to operation 1204, the system can access a plurality of manager level analytics/statistics that have been tracked and recorded for review by various manager level employees. For example, as described above with reference to FIG. 10, in various embodiments the system retains all data/observations related employee performance as part of the system's historical file. As such, the status of all employees is tracked for reporting purposes.

In such embodiments, in operation 1208 and decision block 1212, a manager can choose between various types of observation reports for manager review. For example, as shown in decision block 1212 and in operations 1216, 1218, 1220, these manager reports include various types of observations including service time reports, departmental metrics, an operational efficiency/effectiveness reports.

Referring specifically to FIG. 12, in various embodiments, at decision block 1222, a manager can review whether any real-time alerts have been generated. If in certain embodiments, there are real-time alters that have been generated by the system then, the process 1200 proceeds to operation 1226. Otherwise, in various embodiments, if there are no real-time alerts the process 1200 terminates.

Referring to FIG. 12, in certain embodiments, decision block 1222 is optional and the process 1300 can exclude this step with the process 1300 directly proceeding to operation 1226.

Referring again to FIGS. 12 and 13, in various embodiments, in operation 1226, once the reports have been accessed by the manager the manager can act or make various decisions for adjusting service standards, staffing, or other decisions. In such embodiments decisions can be made using a variety of service reports 1230 that are generated by the system for the selected management report.

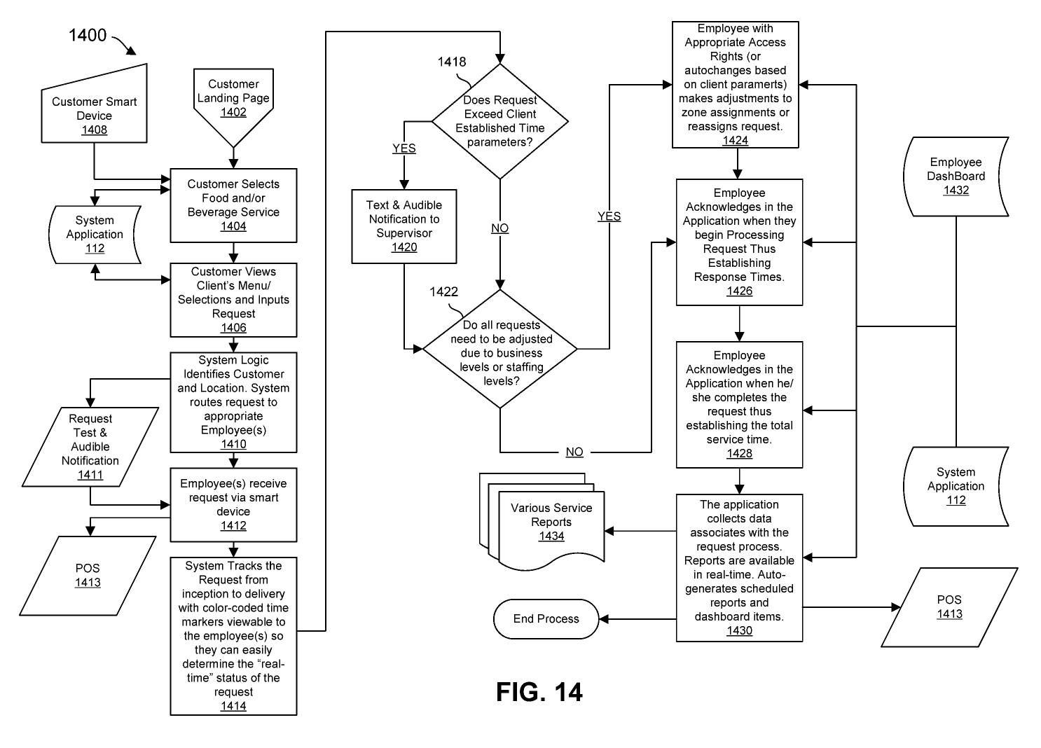

Referring to FIG. 14, depicts a process 1400 flow diagram illustrating the Food and/or Beverage Service process/functionality of the system for service metric data management, according to one or more embodiments of the disclosure.

In one or more embodiments, at operations 1402, 1404, and 1406, the process 1400 includes accessing a customer landing page using a customer smart device 308 and or an Application 122, as described above with reference to FIGS. 1-2. In various embodiments, customer smart device 1408 is a computing node such as computing node 104, 106, 108, described above with reference to FIGS. 1-2.

In various embodiments the customer landing page allows a customer to request a business product or service. For example, in operations 1404 and 1406, the customer can select a food and/or beverage service, view various client menu selections, and input their selection thereby requesting a food and/or beverage service. In such embodiments, the customer landing page displays various menus/selections for a customer and is configured to receive the serve request and forward the request to a server device. As described above, in various embodiments, the customer landing page provides customers with an automated ability to order beverages/food/purchased item “On Demand” through their smart device utilizing a restricted URL thereby allowing a beverage or food service to only be accessed within a specific network. In various embodiments access to the food/beverage/other purchased time request occurs when the customer logs into designated “free Wi-Fi” and is directed to the customer landing page.

In one or more embodiments at operations 1410 and 1412, the system uses various application logic to assign the request to an employee client device. In various embodiments the system notifies an employee of the assigned service request and indicates the nature of the service request, location of the customer, and other relevant information to the employee. For example, in various embodiments the process 1400 includes sending a text and/or audible notification 1411 to the employee via their client device. In such embodiments, the server device can confirm the request using the employee client device. In addition, in certain embodiments, the employee can interact with a point-of-sale (POS) system 1413 for the kitchen/service bar/other location to confirm the request and/or complete the transaction where the client charges for the requested service.

In addition, in various embodiments, at operation 1414, the system monitors the status of the assigned tasks for each employee from inception to fulfillment of the service request. For example, in various embodiments the system maintains a status of all pending service requests and tracks the time from confirmation of the request to the fulfillment of the request for each employee. In such embodiments, upon order submittal, the process tracks the time it takes for the item to be picked-up and delivered. In one or more embodiments the service queue display is shown on the employee tablet or client device and service pick-up location device, the item ordered, an “accepted” and a “delivered” button.

In one or more embodiments, the system is configured to compare the tracked time with preset, predetermined, or otherwise known parameters for service standards. In various embodiments the service standards are preset delivery time or service time thresholds that indicate an acceptable time for completion of the service request. For example, the system could be configured to have a service time threshold for response to service request for a drink order of three minutes, however any amount of time could be set for the service time threshold. As such, in certain embodiments the system tracks the order from inception to completion and compares the tracked time with the three-minute threshold.

In certain embodiments, in decision block 1418, if the response time exceeds the threshold, the system notifies a supervisor of the delay at operation 1420. For example, in some embodiments system generated reports detailing runner and location activity are sent to a predetermined group with text alerts or other system alerts and escalations if preset thresholds are exceeded. Otherwise, decision block 1418 proceeds to decision block 1422 without notifying a supervisor.

In various embodiments, the system could use multiple thresholds indicating varying levels of acceptable performance. For example, the system could employ three thresholds corresponding to “excellent” “acceptable” and “unacceptable” performance standards. In certain embodiments, the system uses color-coded time markers to indicate the status of the request to an employee for ease of determining the real time status of the order. For example, in certain embodiments the system could employ a green-colored marker to indicate service that satisfies an “excellent” service threshold, a yellow-colored marker to indicate a service that satisfies an “acceptable” service threshold, and a red-colored marker to indicate a service that satisfies an unacceptable service threshold. In other embodiments, other types of visual indicators could be used, and even other types of indicators, such as audible indicators, could be used.

In certain embodiments, at decision block 1422, the system can set or adjust standards or thresholds for service requests. For example, in various embodiments end users with management access can set and change the routing of the service requests, as business and staffing levels dictate, through a dashboard with appropriate level permission access. In such embodiments these dashboard routing changes can be completed in real time or preset in anticipation of business level fluctuations.

In some embodiments, such adjustment can be based on business levels or staffing levels. For example, in some instances performance thresholds could be lengthened in instances where staffing is insufficient, when the quantity of service requests is exceeds some threshold, or based on other factors. In certain embodiments, the thresholds for service requests could be adjusted based on user data for a customer. For example, in some embodiments, the system could set lower or higher service standard for a customer request based on, for example, the customer's loyalty tier status. As such, the system could set a corresponding longer or shorter service threshold time for response to a service request from a user.

In some embodiments, instead of adjusting service standards or thresholds for service requests, the system can set or adjust the employees assigned to the request or the general assignment for an employee. For example, in some embodiments the system could reassign some employees from one area with relatively fewer service requests to another area with a greater number of service requests.

As such, in one or more embodiments, if standards or thresholds for service requests need to be adjusted, then process 1400 proceeds to operation 1424, where service standards can be adjusted, as described above. In various embodiments such adjustments can be made manually, by an employee with appropriate access rights and/or automatically, where the system is configured to make one or more automatic adjustments based on preset client parameters. In one or more embodiments, the process 300 then proceeds to operation 326.

Otherwise, if at decision block 1422, no adjustment is needed, the process 1400 skips operation 1424 and proceeds directly to operation 1426. In various embodiments, at operations 1426, and 1428 the process 1400 includes receiving acknowledgement from an assigned employee when they begin processing a service request and when the service request is completed. In various embodiments, by receiving an acknowledgement that the employee has begun to process a service request, the system can begin to track various service metrics, such as for example, the response time of the employee from acceptance until completion of the service request. As such, in operation 1428, when the employee completes the service request and sends an acknowledgement of service completion, the system can record the total service time for evaluation/tracking of employee performance. In certain embodiments the client device for the employee includes a display with “accepted” and “delivered” buttons for indicating the acknowledgement and completion of a service request. In such embodiments, upon receiving the order, the pick-up location begins production of the order. Upon pick-up, the employee delivering the item activates the pickup button on the smart device. Once the item is delivered the employee activates the delivered button on the smart device. In certain embodiments, these buttons are color-coded based upon clients preset service time thresholds, as described above.

In various embodiments, at operation 1430, the system can generate service metric data or service reports 1434 from this information. For example, in various embodiments, service metric data includes response times for fulfillment of service requests, comparison of the response times with service standards, customer reviews or ratings, customer complaints generated, and other indicators of employee performance. In addition, in certain embodiments, the employee can again interact with a point-of-sale (POS) system 1413 for the kitchen/service bar/other location to confirm the request and/or complete the transaction where the client charges for the requested service.

In certain embodiments, for at least operations 1424, 1426, 1428, and 1430, an employee interacts with the system via an employee device that provides access to application 112 via an employee dashboard 1432 or other interface that allows for input to the system.

In certain embodiments, where applicable, the system can integrate with third party systems. This interface provides ordered items data as necessary to record the transaction activity to end user management's point of sale system. Further, the interface also provides that the ordered item can subsequently be settled by end user employee personnel at a later point.

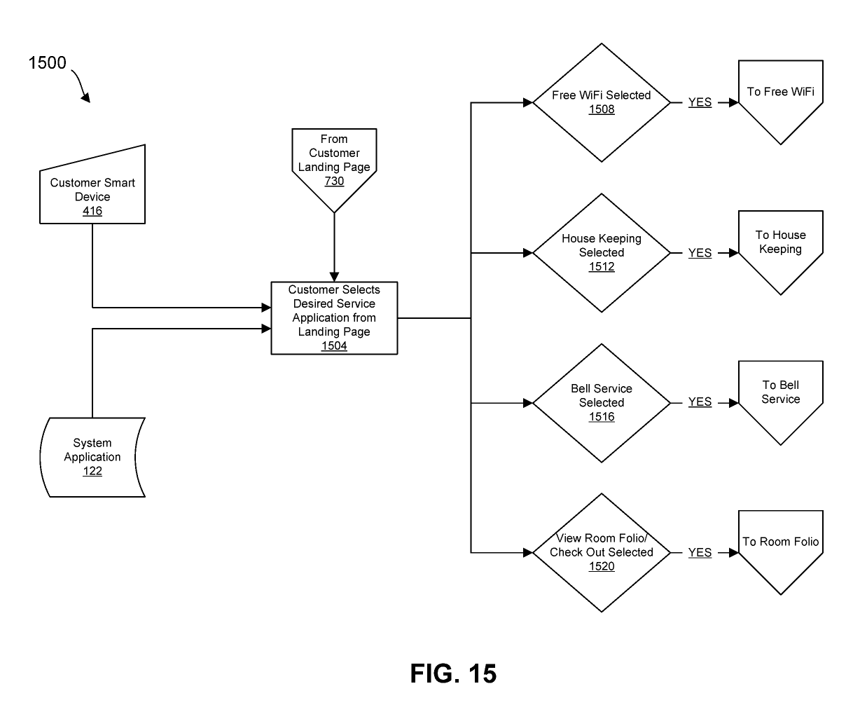

Referring to FIG. 15, a process 1500 flow diagram illustrating the Hotel Services process/functionality of the system for service metric data management is depicted, according to one or more embodiments of the disclosure. As described above with reference to FIGS. 4 and 7, when an end user 414 accesses the functionality of the system through the application 122, the end user is directed to a customer landing page 730. As described above, with reference to FIG. 7, in various embodiments the customer landing 730 page can include promotional offers, customer surveys, contest, and described further below, and include functionality for the end user to review and request various services. In such embodiments, in certain embodiments the service request functionality is capable of a variety of service functions. For example, as depicted in operations 1504, 1508, 1512, 1516, 1520 in various embodiments the system is capable of providing a variety of hotel services for access by the end user. In various embodiments these hotel services can include free Wi-Fi access, house-keeping services, bell service, and check-out/room folio services. However, these services are intended only as examples, and any type or kind of hotel service could be accessed by an end user from the customer landing page.

For example, in certain embodiments, the system displays customer landing pages' functionality is determined by end user managers. In various embodiments the system provides an easily customized landing page presented to customers as they connect to the Internet.

In various embodiments, the customer landing page allows the end user to select and access various hotel survives using their client device. As such, depicted in FIG. 15, once the end user selects the presented service the system records their request and initiates the selected service process. In such embodiments, the system can record/track end user selections to facilitate management or other employees with the ability to monitor, to report and to manage end users guest facing business operation.

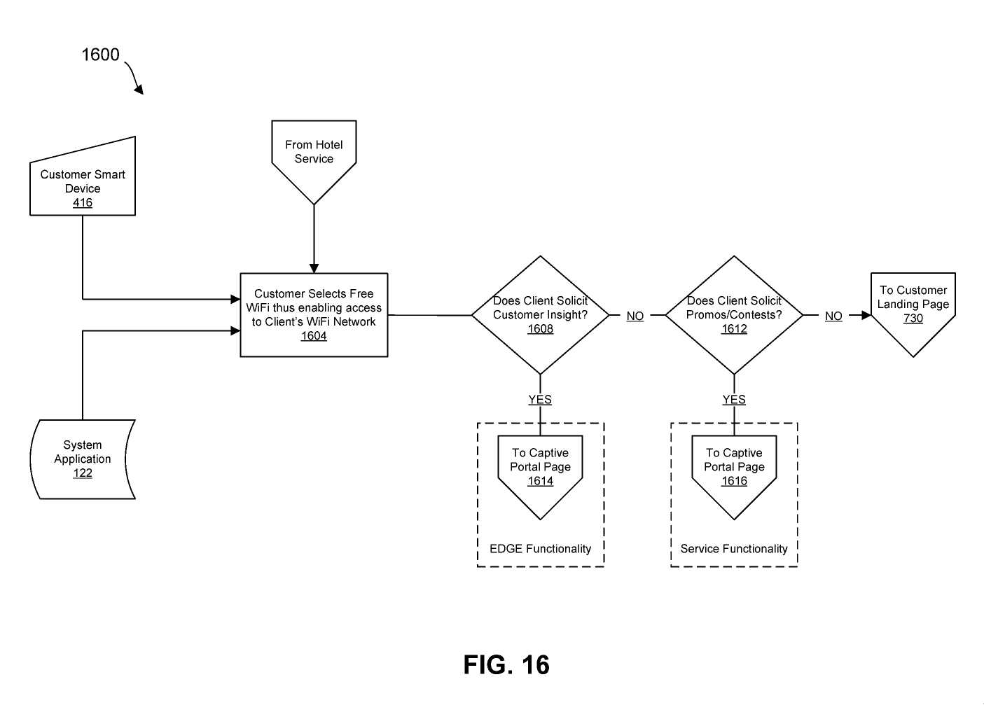

Referring to FIG. 16, this figure depicts a process 1600 illustrating the Free Wi-Fi process/functionality of the system for service metric data management, according to one or more embodiments of the disclosure.

The Hotel Free Wi-Fi Service Request (and other facility access point locations) product identifies users based on various statuses including customer, employee, manager, department, time of day, location, items ordered, spend and other relevant system parameters. In exchange for accessing free Wi-Fi, the guest would be required to take a short survey relative to customer satisfaction, marketing feedback or other customer insight. Once a survey is completed the customer would be directed to the Internet. The process tracks and monitors location where “sign-on” to the system occurs. The management end user can preset parameters to send out automated text messages, system messages and specific customer insight surveys to end users based on location. The process then utilizes logic to route observations, service times and other metrics to specific management to report in both real-time and post-fact basis.

As described above with reference to FIG. 15, an end user can access the functionality of the system through the application 122, via a smart device 416, where the end user is directed to a customer landing page 730. As described above, with reference to FIG. 16, in various embodiments the customer landing page can include a variety of service functions, including free Wi-Fi access. In various embodiments, the customer landing page allows the end user to select and access this service using their client device 416. As such, depicted in FIG. 16, in operation 1604, once the end user selects the free WiFi service, the service the system records their request and initiates the selected service process, enabling access to the client's Wi-Fi network. In such embodiments, the system can record/track end user selections to facilitate management or other employees with the ability to monitor, to report and to manage end users guest facing business operation.

In various embodiments the process 1600 then proceeds from operation 1604 to decision blocks 1608 and 1612, where the system can solicit various customer feedback or participation in various marketing promotions/contests. In such embodiments, the system can solicit various customer feedback mechanisms, such as customer surveys, reviews, etc., and/or offer participation in various client marking promotions contests. In some embodiments, the system can be configured to receive participation or customer feedback as a condition of the offered service. Depicted in FIG. 16, if the customer end user agrees to either solicitation in decision blocks 1608, 1612, the system transfers the end user to an appropriate captive portal page 1614, 1616 included as part of either the EDGE functionality of the system or the service Functionality of the system. Otherwise, in various embodiments, the process 1600 simply returns the customer end user to the customer landing page

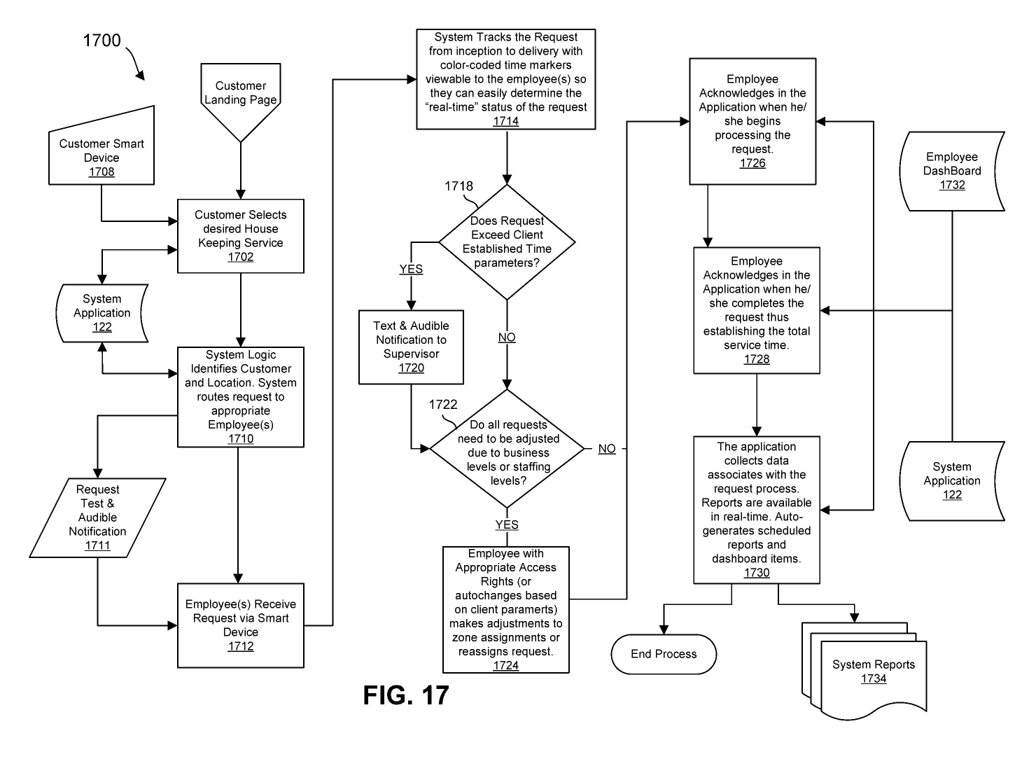

Referring to FIG. 17, depicts a process 1700 flow diagram illustrating the Hotel Housekeeping process/functionality of the system for service metric data management, according to one or more embodiments of the disclosure. In one or more embodiments, at operation 1702, the process 1700 includes accessing a customer landing page using a customer smart device 308 and/or an Application 122, as described above with reference to FIGS. 1-2. In various embodiments, customer smart device 1708 is a computing node such as computing node 104, 106, 108, described above with reference to FIGS. 1-2.

In various embodiments the customer landing page allows a customer to request a business product or service. For example, in operation 1702, the customer can request a housekeeping service, review various menu selections, such as a list of common housekeeping requests, and input their selection thereby requesting a specific housekeeping service.

In such embodiments, the customer landing page displays various menus/selections for a customer and is configured to receive the serve request and forward the request to a server device. As described above, in various embodiments, the customer landing page provides customers with an automated ability to order housekeeping services “On Demand” through their smart device utilizing a restricted URL thereby allowing the customer landing page to only be accessed within a specific network. In various embodiments access to the housekeeping request occurs when the customer logs into designated “free Wi-Fi” and is directed to the customer landing page.

In one or more embodiments at operations 1710 and 1712, the system uses various application logic to assign the request to an employee client device. In various embodiments the system notifies an employee of the assigned service request and indicates the nature of the service request, location of the customer, and other relevant information to the employee. For example, in various embodiments the process 1700 includes sending a text and/or audible notification 1711 to the employee via their client device. In such embodiments, the server device can confirm the request using the employee client device.

In addition, in various embodiments, at operation 1714, the system monitors the status of the assigned tasks for each employee from inception to fulfillment of the service request. For example, in various embodiments the system maintains a status of all pending service requests and tracks the time from confirmation of the request to the fulfillment of the request for each employee. In such embodiments, upon order submittal, the process tracks the time it takes for the service task to be initiated and then completed. In one or more embodiments the service queue display is shown on the employee tablet or client device and service location, the service request, and “start” and “complete” buttons.

In one or more embodiments, the system is configured to compare the tracked time with preset or known parameters for service standards. In various embodiments the service standards are preset delivery time or service time thresholds that indicate an acceptable time for completion of the service request. For example, the system could be configured to have a service time threshold for response to service request for a housekeeping request of 30 minutes, however any amount of time could be set for the service time threshold. As such, in certain embodiments the system tracks the order from inception to completion and compares the tracked time with the 30 minute threshold. In certain embodiments, in decision block 1718, if the response time exceeds the threshold, the system notifies a supervisor of the delay at operation 1720. For example, in some embodiments system generated reports detailing runner and location activity are sent to a predetermined group with text alerts or other system alerts and escalations if preset thresholds are exceeded. Otherwise, decision block 1718 proceeds to decision block 1722 without notifying a supervisor.

In various embodiments, the system could use multiple thresholds indicating varying levels of acceptable performance. For example, the system could employ three thresholds corresponding to “excellent” “acceptable” and “unacceptable” performance standards. In certain embodiments, the system uses color-coded time markers to indicate the status of the request to an employee for ease of determining the real time status of the order. For example, in certain embodiments the system could employ a green-colored marker to indicate service that satisfies an “excellent” service threshold, a yellow-colored marker to indicate a service that satisfies an “acceptable” service threshold, and a red-colored marker to indicate a service that satisfies an unacceptable service threshold.

In certain embodiments, at decision block 1722, the system can set or adjust standards or thresholds for service requests. For example, in various embodiments end users with management access can set and change the routing of the service requests, as business and staffing levels dictate, through a dashboard with appropriate level permission access. In such embodiments these dashboard routing changes can be completed in real time or preset in anticipation of business level fluctuations.

In some embodiments, such adjustment can be based on business levels or staffing levels. For example, in some instances performance thresholds could be lengthened in instances where staffing is insufficient, when the quantity of service requests is exceeds some threshold, or based on other factors. In certain embodiments, the thresholds for service requests could be adjusted based on user data for a customer. For example, in some embodiments, the system could set lower or higher service standard for a customer request based on, for example, the customer's loyalty tier status. As such, the system could set a corresponding longer or shorter service threshold time for response to a service request from a user.

In some embodiments, instead of adjusting service standards or thresholds for service requests, the system can set or adjust the employees assigned to the request or the general assignment for an employee. For example, in some embodiments the system could reassign some employees from one area with relatively fewer service requests to another area with a greater number of service requests.

As such, in one or more embodiments, if standards or thresholds for service requests need to be adjusted, then process 1700 proceeds to operation 1724, where service standards can be adjusted, as described above. In various embodiments such adjustments can be made manually, by an employee with appropriate access rights and/or automatically, where the system is configured to make one or more automatic adjustments based on preset client parameters. In one or more embodiments, the process 1700 then proceeds to operation 1726.

Otherwise, if at decision block 1722, no adjustment is needed, the process 1700 skips operation 1724 and proceeds directly to operation 1726. In various embodiments, at operations 1726, and 1728 the process 1700 includes receiving acknowledgement from an assigned employee when they begin processing a service request and when the service request is completed. In various embodiments, by receiving an acknowledgement that the employee has begun to process a service request, the system can begin to track various service metrics, such as for example, the response time of the employee from acceptance until completion of the service request. As such, in operation 1728, when the employee completes the service request and sends an acknowledgement of service completion, the system can record the total service time for evaluation/tracking of employee performance. In certain embodiments the client device for the employee includes a display with “accepted” and “delivered” buttons for indicating the acknowledgement and completion of a service request. In such embodiments, upon receiving the order, the pick-up location begins production of the order. Upon pick-up, the employee delivering the item activates the pickup button on the smart device. Once the item is delivered the employee activates the delivered button on the smart device. In certain embodiments, these buttons are color-coded based upon clients preset service time thresholds, as described above.

In various embodiments, at operation 1730, the system can generate service metric data or service reports 1734 from this information. For example, in various embodiments, service metric data includes response times for fulfillment of service requests, comparison of the response times with service standards, customer reviews or ratings, customer complaints generated, and other indicators of employee performance.

In certain embodiments, for at least operations 1724, 1726, 1728, and 1730, an employee interacts with the system via an employee device that provides access to application 122 via an employee dashboard 1732 or other interface that allows for input to the system.

In certain embodiments, where applicable, the system can integrate with third party systems. This interface provides ordered items data as necessary to record the transaction activity to end user management's point of sale system. Further, the interface also provides that the ordered item can subsequently be settled by end user employee personnel at a later point.

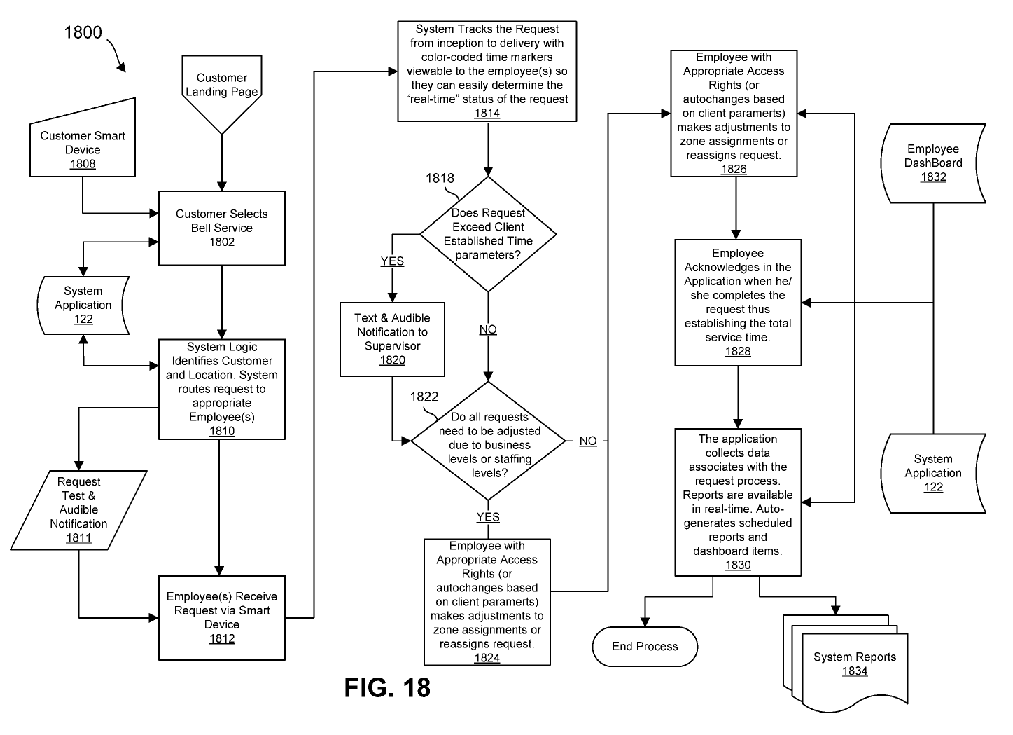

Referring to FIG. 18, a process 1800 flow diagram illustrating the Bell Service process/functionality of the system for service metric data management is depicted, according to one or more embodiments of the disclosure. In one or more embodiments, at operation 1802, the process 1800 includes accessing a customer landing page using a customer smart device 1808 and/or an Application 122, as described above with reference to FIGS. 1-2. In various embodiments, customer smart device 1808 is a computing node such as computing node 104, 106, 108, described above with reference to FIGS. 1-2.

In various embodiments the customer landing page allows a customer to request a business product or service. For example, in operation 1802, the customer can select request a housekeeping service, review various menu selections, such as a list of common bell requests, and input their selection thereby requesting a specific bell service.

In such embodiments, the customer landing page displays various menus/selections for a customer and is configured to receive the serve request and forward the request to a server device. As described above, in various embodiments, the customer landing page provides customers with an automated ability to order bell services “On Demand” through their smart device utilizing a restricted URL thereby allowing the customer landing page to only be accessed within a specific network. In various embodiments access to the housekeeping request occurs when the customer logs into designated “free Wi-Fi” and is directed to the customer landing page.

In one or more embodiments at operations 1810 and 1812, the system uses various application logic to assign the request to an employee client device. In various embodiments the system notifies an employee of the assigned service request and indicates the nature of the service request, location of the customer, and other relevant information to the employee. For example, in various embodiments the process 1800 includes sending a text and/or audible notification 1811 to the employee via their client device. In such embodiments, the server device can confirm the request using the employee client device.

In addition, in various embodiments, at operation 1814, the system monitors the status of the assigned tasks for each employee from inception to fulfillment of the service request. For example, in various embodiments the system maintains a status of all pending service requests and tracks the time from confirmation of the request to the fulfillment of the request for each employee. In such embodiments, upon order submittal, the process tracks the time it takes for the service task to be initiated and then completed. In one or more embodiments the service queue display is shown on the employee tablet or client device and service location, the service request, and “start” and “complete” buttons.

In one or more embodiments, the system is configured to compare the tracked time with preset or known parameters for service standards. In various embodiments the service standards are preset delivery time or service time thresholds that indicate an acceptable time for completion of the service request. For example, the system could be configured to have a service-time threshold for response to service request for a bell service request of 30 minutes, however any amount of time could be set for the service time threshold. As such, in certain embodiments the system tracks the order from inception to completion and compares the tracked time with the 30 minute threshold. In certain embodiments, in decision block 1818, if the response time exceeds the threshold, the system notifies a supervisor of the delay at operation 1820. For example, in some embodiments system generated reports detailing runner and location activity are sent to a predetermined group with text alerts or other system alerts and escalations if preset thresholds are exceeded. Otherwise, decision block 1818 proceeds to decision block 1822 without notifying a supervisor.

In various embodiments, the system could use multiple thresholds indicating varying levels of acceptable performance. For example, the system could employ three thresholds corresponding to “excellent” “acceptable” and “unacceptable” performance standards. In certain embodiments, the system uses color-coded time markers to indicate the status of the request to an employee for ease of determining the real time status of the order. For example, in certain embodiments the system could employ a green-colored marker to indicate service that satisfies an “excellent” service threshold, a yellow-colored marker to indicate a service that satisfies an “acceptable” service threshold, and a red-colored marker to indicate a service that satisfies an unacceptable service threshold.

In certain embodiments, at decision block 1822, the system can set or adjust standards or thresholds for service requests. For example, in various embodiments end users with management access can set and change the routing of the service requests, as business and staffing levels dictate, through a dashboard with appropriate level permission access. In such embodiments these dashboard routing changes can be completed in real time or preset in anticipation of business level fluctuations.

In some embodiments, such adjustment can be based on business levels or staffing levels. For example, in some instances performance thresholds could be lengthened in instances where staffing is insufficient, when the quantity of service requests is exceeds some threshold, or based on other factors. In certain embodiments, the thresholds for service requests could be adjusted based on user data for a customer. For example, in some embodiments, the system could set lower or higher service standard for a customer request based on, for example, the customer's loyalty tier status. As such, the system could set a corresponding longer or shorter service threshold time for response to a service request from a user.

In some embodiments, instead of adjusting service standards or thresholds for service requests, the system can set or adjust the employees assigned to the request or the general assignment for an employee. For example, in some embodiments the system could reassign some employees from one area with relatively fewer service requests to another area with a greater number of service requests.

As such, in one or more embodiments, if standards or thresholds for service requests need to be adjusted, then process 1800 proceeds to operation 1824, where service standards can be adjusted, as described above. In various embodiments such adjustments can be made manually, by an employee with appropriate access rights and/or automatically, where the system is configured to make one or more automatic adjustments based on preset client parameters. In one or more embodiments, the process 1800 then proceeds to operation 1826.

Otherwise, if at decision block 1822, no adjustment is needed, the process 1800 skips operation 1824 and proceeds directly to operation 1826. In various embodiments, at operations 1826, and 1828 the process 1800 includes receiving acknowledgement from an assigned employee when they begin processing a service request and when the service request is completed. In various embodiments, by receiving an acknowledgement that the employee has begun to process a service request, the system can begin to track various service metrics, such as for example, the response time of the employee from acceptance until completion of the service request. As such, in operation 1828, when the employee completes the service request and sends an acknowledgement of service completion, the system can record the total service time for evaluation/tracking of employee performance. In certain embodiments the client device for the employee includes a display with “accepted” and “delivered” buttons for indicating the acknowledgement and completion of a service request. In such embodiments, upon receiving the order, the pick-up location begins production of the order. Upon pick-up, the employee delivering the item activates the pickup button on the smart device. Once the item is delivered the employee activates the delivered button on the smart device. In certain embodiments, these buttons are color-coded based upon clients preset service time thresholds, as described above.

In various embodiments, at operation 1830, the system can generate service metric data or service reports 1834 from this information. For example, in various embodiments, service metric data includes response times for fulfillment of service requests, comparison of the response times with service standards, customer reviews or ratings, customer complaints generated, and other indicators of employee performance.

In certain embodiments, for at least operations 1824, 1826, 1828, and 1830, an employee interacts with the system via an employee device that provides access to application 122 via an employee dashboard 1832 or other interface that allows for input to the system.

In certain embodiments, where applicable, the system can integrate with third party systems. This interface provides ordered items data as necessary to record the transaction activity to end user management's point of sale system. Further, the interface also provides that the ordered item can subsequently be settled by end user employee personnel at a later point.

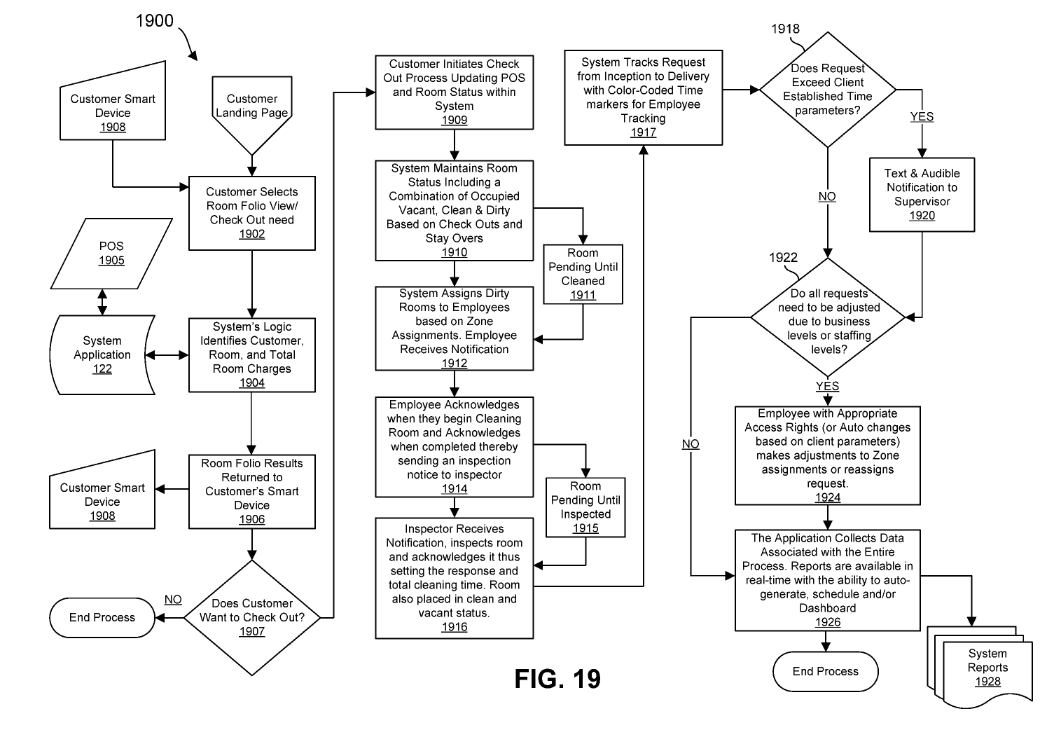

Referring to FIG. 19, a process 1900 flow diagram illustrating the Room Folio View/Check-Out process functionality of the system for service metric data management is depicted, according to one or more embodiments of the disclosure. In one or more embodiments, at operation 1902, the process 1900 includes accessing a customer landing page using a customer smart device 1908 and/or an Application 122, as described above with reference to FIGS. 1-2. In various embodiments, customer smart device 1908 is a computing node such as computing node 104, 106, 108, described above with reference to FIGS. 1-2.

In various embodiments the customer landing page allows a customer to request a business product or service. For example, in operation 1902, the customer can select check-out services, can select folio review, and input their selection using the smart device 1908.

In such embodiments, the customer landing page displays various menus/selections for a customer and is configured to receive and process a user selected service request. For example, as described above, in various embodiments, the customer landing page provides customers with an automated ability to initiate a hotel “check-out” process and review their room folio through a smart device utilizing a restricted URL thereby allowing the customer landing page to only be accessed within a specific network. In various embodiments access to these services occurs when the customer logs into designated “free Wi-Fi” and is directed to the customer landing page.

In one or more embodiments at operation 1904 the system uses various application logic to identify the end user, their room, and total room charges. For example, in various embodiments the room folio view/check-out service request function identifies users based on various information including room number and/or secondary identification such as phone number, credit card number, or the like. In such embodiments, the system can automatically identify the guest and then allow the guest “read only” access to their room charges folio with the additional ability to check out.

In some embodiments, the landing page additionally allows the end user to settle various outstanding room charges via access to an online POS system 1905. For example, in various embodiments the process 1900 includes accessing the POS system 1905 via the application 122 for initiating payment of various outstanding room charges. In such embodiments the end user can interact with the POS system 1905 via the application 122 to settle any pending charges and complete the check-out process. In certain embodiments, where applicable, the system can integrate with third party systems. This interface provides ordered items data as necessary to record the transaction activity to end user management's point of sale system. Further, the interface also provides that the charges can subsequently be settled by end user employee personnel at a later point.

In various embodiments, at operation 1906, the requested room folio results are returned to the end user's smart device 1908 for review by the end user. In such embodiments, the view room folio functionality of the customer landing page provides customers with an automated ability to view their room folio and/or check out “On Demand” through their smart device utilizing a restricted URL request button that can only be accessed within a specific network. Access to the Request occurs either when the customer logs into designated “free Wi-fi”, or selects a Service App, and is directed to a landing page.

In various embodiments, the process 1900 includes, at decision block 1907, determine whether the customer wishes to check out. If the end user indicates that they want to check out, the process 1900 progresses to operation 1909, where the customer initiates the checkout process. In various embodiments, once the end user initiates the checkout process the system updates their status within the system. For example, in various embodiments, the system can place the relevant room as ready for housekeeping or turnover service. From the landing page, the customer can select services. Once submitted the checkout is simultaneously sent to a “rooms to be cleaned” housekeeping service queue displaying on the employee's smart device.

In various embodiments, referring to operations 1910, 1912, 1914, 1916, the system is configured to maintain a database of room statuses including a combination of occupied, vacant, clean, and dirty rooms. In such embodiments, rooms are automatically categorized and moved between categories based on feedback received by employee and customer end users. For example in various embodiments feedback from customer end users and employee end users will automatically move rooms into one of the various room statuses. For example, in operation 1911, once a check out request is submitted the room is automatically categorized as “vacant” and as “dirty”. In such embodiments, the dirty status remains pending until an employee end user indicates to the system that the room has been cleaned. As a result, in various embodiments the system records maintains an automated listing of rooms needing to be cleaned. Also, recorded to the same listing of rooms needing cleaning are rooms that are “occupied but dirty”, rooms “checked out” by either front desk personnel or automatically checked out based on “due out's”.

In operation 1912, the system assigns dirty rooms to employee end user for initiation of a service request. For example, as described above, the system can notify various employee end users of “rooms to be cleaned”, adding a housekeeping service task to an employee task queue displayed on the employee's smart device.

In operations, 1914, 1915, and 1916, the process 1900 includes receiving acknowledgement from an assigned employee when they begin processing a service request and when the service request is completed. In various embodiments, by receiving an acknowledgement that the employee has begun to process a service request, the system can begin to track various service metrics, such as for example, the response time of the employee from acceptance until completion of the service request. As such, when the employee completes the service request and sends an acknowledgement of service completion, the system can record the total service time for evaluation/tracking of employee performance. In certain embodiments the client device for the employee includes a display with “start” and “completed” buttons for indicating the acknowledgement and completion of a service request. In certain embodiments, these buttons are color-coded based upon clients preset service time thresholds, as described above.

For example, in certain embodiments, upon check-out submittal, the process tracks the time it takes for the end user employee to begin cleaning the room till completion of the task. The service queue display shown on the employee smart device lists service tasks including “Begin Cleaning”, “Room Completed” and “Room Inspected” buttons. Both buttons can be color-coded based upon clients preset thresholds, the employee who cleans the room activates the “Begin” and “Completed” buttons on the smart device. In operation 1915, upon successful inspection a designated inspector activates the “Room Inspected” button on their smart device. Once the request is completed, the process communicates that the room can be entered into the available room inventory.

In addition, in various embodiments, the system monitors the status of the assigned tasks for each employee from inception to fulfillment of the service request. For example, in various embodiments, in operation 1917, the system maintains a status of all pending service requests and tracks the time from confirmation of the request to the fulfillment of the request for each employee. In such embodiments, upon order submittal, the process tracks the time it takes for the service task to be initiated and then completed. In one or more embodiments the service queue display is shown on the employee tablet or client device and service location, the service request, and “start” and “complete” buttons.

In one or more embodiments, the system is configured to compare the tracked time with preset or known parameters for service standards. In various embodiments the service standards are preset delivery time or service time thresholds that indicate an acceptable time for completion of the service request. For example, the system could be configured to have a service time threshold for response to service request for a housekeeping request of 30 minutes, however any amount of time could be set for the service time threshold. As such, in certain embodiments the system tracks the order from inception to completion and compares the tracked time with the 30 minute threshold. In certain embodiments, in decision block 1918, if the response time exceeds the threshold, the system notifies a supervisor of the delay at operation 1920. For example, in some embodiments system generated reports detailing runner and location activity are sent to a predetermined group with text alerts or other system alerts and escalations if preset thresholds are exceeded. Otherwise, decision block 1918 proceeds to decision block 1922 without notifying a supervisor.

In various embodiments, the system could use multiple thresholds indicating varying levels of acceptable performance. For example, the system could employ three thresholds corresponding to “excellent” “acceptable” and “unacceptable” performance standards. In certain embodiments, the system uses color-coded time markers to indicate the status of the request to an employee for ease of determining the real time status of the order. For example, in certain embodiments the system could employ a green-colored marker to indicate service that satisfies an “excellent” service threshold, a yellow-colored marker to indicate a service that satisfies an “acceptable” service threshold, and a red-colored marker to indicate a service that satisfies an unacceptable service threshold.

In certain embodiments, at decision block 1922, the system can set or adjust standards or thresholds for service requests. For example, in various embodiments end users with management access can set and change the routing of the service requests, as business and staffing levels dictate, through a dashboard with appropriate level permission access. In such embodiments these dashboard routing changes can be completed in real time or preset in anticipation of business level fluctuations.

In some embodiments, such adjustment can be based on business levels or staffing levels. For example, in some instances performance thresholds could be lengthened in instances where staffing is insufficient, when the quantity of service requests is exceeds some threshold, or based on other factors. In certain embodiments, the thresholds for service requests could be adjusted based on user data for a customer. For example, in some embodiments, the system could set lower or higher service standard for a customer request based on, for example, the customer's loyalty tier status. As such, the system could set a corresponding longer or shorter service threshold time for response to a service request from a user.

In some embodiments, instead of adjusting service standards or thresholds for service requests, the system can set or adjust the employees assigned to the request or the general assignment for an employee. For example, in some embodiments the system could reassign some employees from one area with relatively fewer service requests to another area with a greater number of service requests.

As such, in one or more embodiments, if standards or thresholds for service requests need to be adjusted, then process 1900 proceeds to operation 1924, where service standards can be adjusted, as described above. In various embodiments such adjustments can be made manually, by an employee with appropriate access rights and/or automatically, where the system is configured to make one or more automatic adjustments based on preset client parameters. In one or more embodiments, the process 1900 then proceeds to operation 1926.

Otherwise, if at decision block 1922, no adjustment is needed, the process 1900 skips operation 1924 and proceeds directly to operation 1926. In various embodiments, at operation 1926, the system can generate service metric data or service reports 1928 from this information. For example, in various embodiments, service metric data includes response times for fulfillment of service requests, comparison of the response times with service standards, customer reviews or ratings, customer complaints generated, and other indicators of employee performance.

In certain embodiments, for at least operations 1914, 1916, and 1917 an employee interacts with the system via an employee device that provides access to application 122 via an employee dashboard or other interface that allows for input to the system.

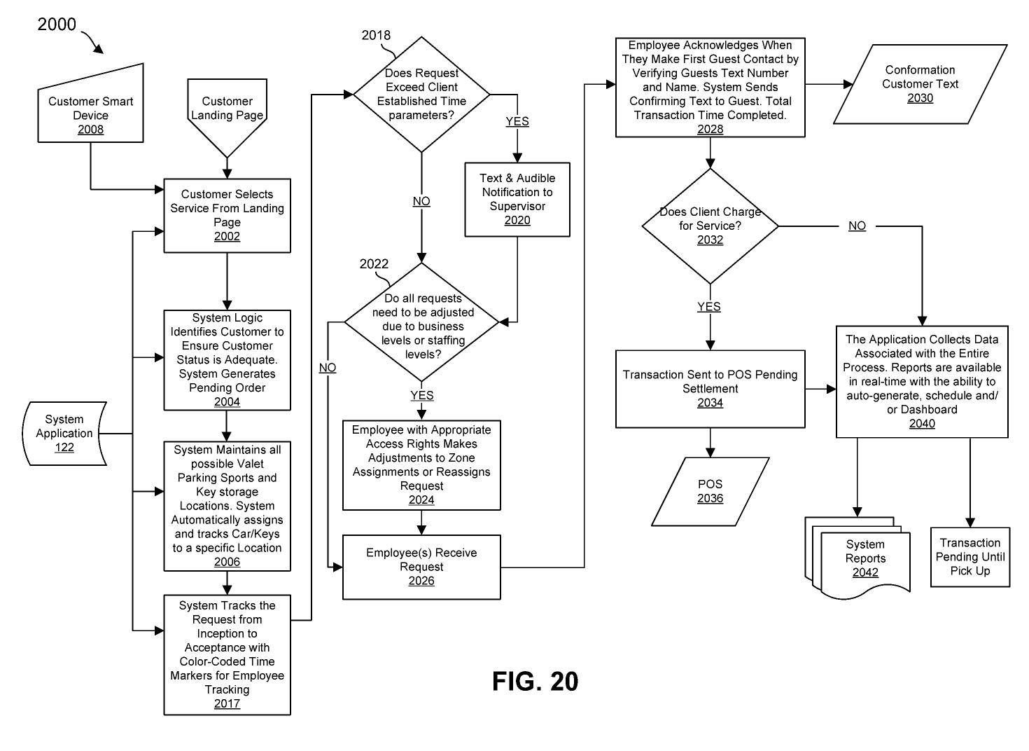

Referring to FIG. 20, a process 2000 flow diagram illustrating the Valet Car Drop Off process/functionality of the system for service metric data management is depicted, according to one or more embodiments of the disclosure. In one or more embodiments, at operation 2002, the process 2000 includes accessing a customer landing page using a customer smart device 2008 and/or an Application 122, as described above with reference to FIGS. 1-2. In various embodiments, customer smart device 2008 is a computing node such as computing node 104, 106, 108, described above with reference to FIGS. 1-2.

In various embodiments the customer landing page allows a customer to request a business product or service. For example, in operation 2002, the customer can review various valet services and input their selection using the smart device 2008 and application 122. In such embodiments, the customer landing page displays various menus/selections for a customer and is configured to receive and process a user selected service request. For example, as described above, in various embodiments, the customer landing page provides customers with an automated ability to initiate a valet process through a smart device utilizing a restricted URL thereby allowing the customer landing page to only be accessed within a specific network. In various embodiments access to these services occurs when the customer logs into designated “free Wi-Fi” and is directed to the customer landing page. In various embodiments, once the valet service request has been accepted by the process the guest originating the request receives an automated text listing a unique “e-ticket” number, short vehicle description and a link to be used for requesting vehicle pickup. Described further, below, in various embodiments, once the valet service request is submitted, the request is simultaneously routed to employee(s) who will receive the item to a service queue displaying on the employee's smart device.

In one or more embodiments at operation 2004 the system uses various application logic to identify the end user, determine an end user status, and generate service orders. For example, in various embodiments the Valet Drop-Off Service Request functionality identifies users based on their unique full or partial cell phone number and then access a description of vehicle being dropped off from drop down lists of common vehicle descriptions and colors or enter into a text box any vehicle description not listed. In some embodiments the system can additional identify the end user based on their status as a customer, employee, manager, department, time of day, their location and other relevant system parameters.

In various embodiments, referring to operation 2006, the system is configured to maintain a database of all possible valet parking spots and key storage locations. For example, in various embodiments the system maintains an inventory of all parking spots and associated key storage spaces where vehicles and associated keys are stored. In such embodiments the system automatically assigns the vehicle/keys to an appropriate storage location. In such embodiments feedback from customer end users and employee end users will automatically update the status of the possible valet parking sports and key storage locations. For example, in certain embodiments, once a valet drop off request is submitted the system automatically categorizes the parking space and/or key storage space as “vacant”. In some embodiments, the vacant status of the parking space and/or key storage first awaits confirmation or is listed as “pending” until an employee end user indicates to the system that the parking space is indeed vacant. As a result, in various embodiments the system records maintains an automated listing of vacant and occupied parking spaces and/or key storage.

In various embodiments, at operation 2017, upon valet service request submittal, the process 2000 tracks the time it takes for the end user employee to make first contact with the customer till completion of the task. The service queue display shown on the employee smart device lists Valet Drop Off request including “e-ticket” number, assigned location, “Drop Off” and “Completed” buttons. The end user employee is given the vehicle/keys by the customer, and attaches an automated ticket that displays the customer cell number, assigned key storage location and brief description of the vehicle.

In various embodiments, the system assigns valet service tasks to employee end users upon customer initiation of a service request. For example, as described above, the system can notify various employee end users of “valet request”, indicating a key location and a tracked vehicle location and the service request within an employee task queue displayed on the employee's smart device.

In one or more embodiments the system tracks and monitors information from inception, or vehicle drop off, to, completion, or vehicle pickup with color-coded time markers or other similar alert methods indicated to the employees so they can easily determine the real-time status of the information. The management end user can preset parameters to send out automated text messages or other system alerts when the information exceeds predetermined thresholds. The process then utilizes logic to route observations, service times and other metrics to specific management to report in both real-time and post-fact basis.

In one or more embodiments, the system is configured to compare the tracked time with preset or known parameters for service standards. In various embodiments the service standards are preset delivery time or service time thresholds that indicate an acceptable time for completion of the service request. For example, the system could be configured to have a service time threshold for response to service request for valet service request of 15 minutes, however any amount of time could be set for the service time threshold. As such, in certain embodiments the system tracks the order from inception to completion and compares the tracked time with the 15 minute threshold. In certain embodiments, in decision block 2018, if the response time exceeds the threshold, the system notifies a supervisor of the delay at operation 2020. For example, in some embodiments system generated reports detailing runner and location activity are sent to a predetermined group with text alerts or other system alerts and escalations if preset thresholds are exceeded. Otherwise, decision block 2018 proceeds to decision block 2022 without notifying a supervisor.

In various embodiments, the system could use multiple thresholds indicating varying levels of acceptable performance. For example, the system could employ three thresholds corresponding to “excellent” “acceptable” and “unacceptable” performance standards. In certain embodiments, the system uses color-coded time markers to indicate the status of the request to an employee for ease of determining the real time status of the order. For example, in certain embodiments the system could employ a green-colored marker to indicate service that satisfies an “excellent” service threshold, a yellow-colored marker to indicate a service that satisfies an “acceptable” service threshold, and a red-colored marker to indicate a service that satisfies an unacceptable service threshold.

In certain embodiments, at decision block 2022, the system can set or adjust standards or thresholds for service requests. For example, in various embodiments end users with management access can set and change the routing of the service requests, as business and staffing levels dictate, through a dashboard with appropriate level permission access. In such embodiments these dashboard routing changes can be completed in real time or preset in anticipation of business level fluctuations.

In some embodiments, such adjustment can be based on business levels or staffing levels. For example, in some instances performance thresholds could be lengthened in instances where staffing is insufficient, when the quantity of service requests is exceeds some threshold, or based on other factors. In certain embodiments, the thresholds for service requests could be adjusted based on user data for a customer. For example, in some embodiments, the system could set lower or higher service standard for a customer request based on, for example, the customer's loyalty tier status. As such, the system could set a corresponding longer or shorter service threshold time for response to a service request from a user.

In some embodiments, instead of adjusting service standards or thresholds for service requests, the system can set or adjust the employees assigned to the request or the general assignment for an employee. For example, in some embodiments the system could reassign some employees from one area with relatively fewer service requests to another area with a greater number of service requests.

As such, in one or more embodiments, if standards or thresholds for service requests need to be adjusted, then process 2000 proceeds to operation 2024, where service standards can be adjusted, as described above. In various embodiments such adjustments can be made manually, by an employee with appropriate access rights and/or automatically, where the system is configured to make one or more automatic adjustments based on preset client parameters. In one or more embodiments, the process 2000 then proceeds to operation 2026.

Otherwise, if at decision block 2022, no adjustment is needed, the process 2000 skips operation 2024 and proceeds directly to operation 2026.

In one or more embodiments at operation 2026, the system uses various application logic to assign the request to an employee client device. In various embodiments the system notifies an employee of the assigned service request and indicates the nature of the service request, location of the customer, and other relevant information to the employee. For example, in various embodiments the process 2000 includes sending a text and/or audible notification to the employee via their client device.

In such embodiments, at operation 2028, the employee end user can confirm the request using the employee client device. In certain embodiments operation 2028 includes receiving acknowledgement from an assigned employee when they begin processing a service request and when the service request is completed. In various embodiments, by receiving an acknowledgement that the employee has begun to process a service request, the system can begin to track various service metrics, such as for example, the response time of the employee from acceptance until completion of the service request. As such, when the employee completes the service request and sends an acknowledgement of service completion, the system can record the total service time for evaluation/tracking of employee performance. In certain embodiments the client device for the employee includes a display with “start” and “completed” buttons for indicating the acknowledgement and completion of a service request. In certain embodiments, these buttons are color-coded based upon clients preset service time thresholds, as described above. In various embodiments, the employee end user acknowledges when they begin processing a service request by making first guest contact. In such embodiments, the employee end user can make First Guest Contact by Verifying Guests Text Number and Name. In some embodiments, at operation 2030, the system sends a confirmation text to the customer end user. When the employee acknowledges the service request. In various embodiments, once the task is completed, the employee can indicate the completion of the task using their client device. In various embodiments the system notes the total transaction time.

At decision block 2032, where end user managers require a fee for the requested service, once submitted the drop off is sent to a POS system 2036 to settle payment. In such embodiments the end user can interact with the POS system 2036 via the application 122 to settle any pending charges. In certain embodiments, where applicable, the system can integrate with third party systems. This interface provides ordered items data as necessary to record the transaction activity to end user management's point of sale system. Further, the interface also provides that the charges can subsequently be settled by end user employee personnel at a later point.

Otherwise, in various embodiments, at operation 2040, the system can generate service metric data or service reports 2042 from this information. For example, in various embodiments, service metric data includes response times for fulfillment of service requests, comparison of the response times with service standards, customer reviews or ratings, customer complaints generated, and other indicators of employee performance.

In various embodiments, the transaction remains pending within the system until the vehicle is picked up or the pick-up process is initiated by a customer.

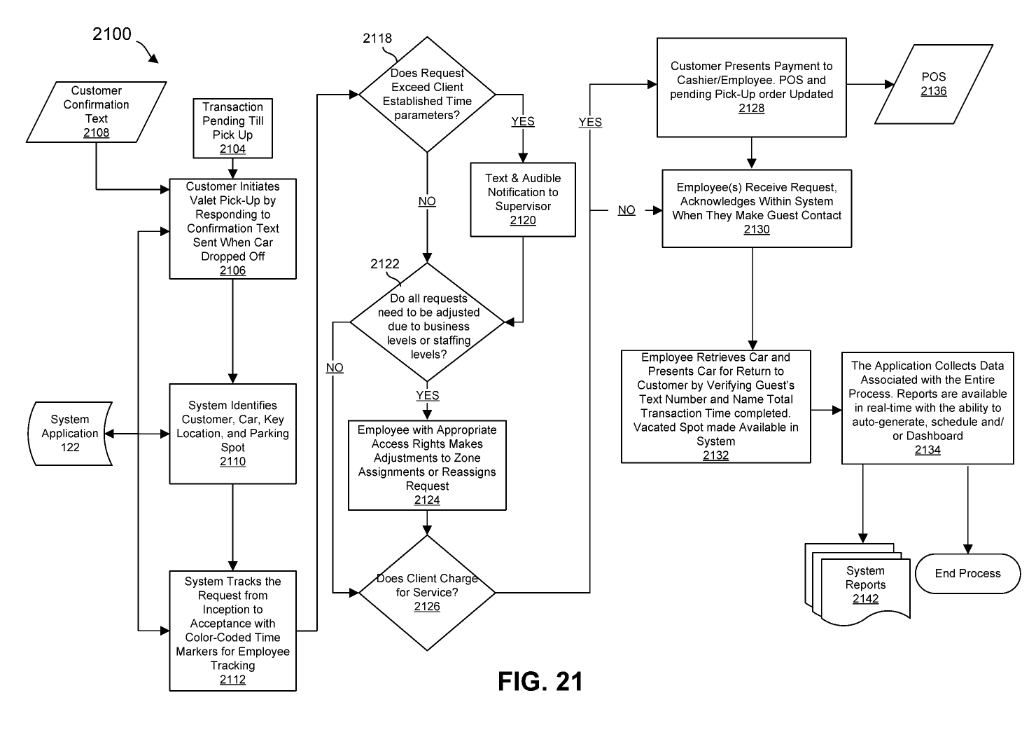

For example, referring to FIG. 21, a process 2100 flow diagram illustrating the Valet Car Pick-Up process/functionality of the system for service metric data management is depicted, according to one or more embodiments of the disclosure. In various embodiments, at operation 2104 the transaction remains pending within the system until the vehicle is picked up or the pick-up process is initiated by a customer. In such embodiments, the customer can initiate a valet pick-up service by responding to a confirmation text 2108 that is sent to the customer when the car is initially parked. However, in certain embodiments the customer can initiate pick up using system application 122, such as through their client device, as described above. In various embodiments the Item Pick-up process provides customers with an automated ability to pick up items previously dropped off through their smart device by utilizing a response link in the drop off “e-ticket” text previously sent to the guest's smart device at drop off.

In one or more embodiments at operation 2110 the system uses various application logic to identify the end user, determine an end user status, and generate service orders. For example, in various embodiments the system is configured to maintain a database of all possible valet parking spots and key storage locations. For example, in various embodiments the system maintains an inventory of all parking spots and associated key storage spaces where vehicles and associated keys are stored. In such embodiments the system automatically identifies the location of the vehicle and key based on the stored data associated with the identified user.

In various embodiments, at operation 2112, upon valet service request submittal, the process 2100 tracks the time it takes for the end user employee to make first contact with the customer till completion of the task. The service queue display shown on the employee smart device lists Valet pick-up request including “e-ticket” number, assigned location, “start” and “completed” buttons. In various embodiments, the system assigns valet service tasks to employee end users upon customer initiation of a service request. For example, as described above, the system can notify various employee end users of “valet request”, indicating a key location and a tracked vehicle location and the service request within an employee task queue displayed on the employee's smart device.

In one or more embodiments the system tracks and monitors information from inception, or vehicle drop off, to, completion, or vehicle pickup with color-coded time markers or other similar alert methods indicated to the employees so they can easily determine the real-time status of the information. The management end user can preset parameters to send out automated text messages or other system alerts when the information exceeds predetermined thresholds. The process then utilizes logic to route observations, service times and other metrics to specific management to report in both real-time and post-fact basis.

In one or more embodiments, the system is configured to compare the tracked time with preset or known parameters for service standards. In various embodiments the service standards are preset delivery time or service time thresholds that indicate an acceptable time for completion of the service request. For example, the system could be configured to have a service time threshold for response to service request for valet service request of 15 minutes, however any amount of time could be set for the service time threshold. As such, in certain embodiments the system tracks the order from inception to completion and compares the tracked time with the 15 minute threshold. In certain embodiments, in decision block 2118, if the response time exceeds the threshold, the system notifies a supervisor of the delay at operation 2120. For example, in some embodiments system generated reports detailing runner and location activity are sent to a predetermined group with text alerts or other system alerts and escalations if preset thresholds are exceeded. Otherwise, decision block 2118 proceeds to decision block 2122 without notifying a supervisor.

In various embodiments, the system could use multiple thresholds indicating varying levels of acceptable performance. For example, the system could employ three thresholds corresponding to “excellent” “acceptable” and “unacceptable” performance standards. In certain embodiments, the system uses color-coded time markers to indicate the status of the request to an employee for ease of determining the real time status of the order. For example, in certain embodiments the system could employ a green-colored marker to indicate service that satisfies an “excellent” service threshold, a yellow-colored marker to indicate a service that satisfies an “acceptable” service threshold, and a red-colored marker to indicate a service that satisfies an unacceptable service threshold.

In certain embodiments, at decision block 2122, the system can set or adjust standards or thresholds for service requests. For example, in various embodiments end users with management access can set and change the routing of the service requests, as business and staffing levels dictate, through a dashboard with appropriate level permission access. In such embodiments these dashboard routing changes can be completed in real time or preset in anticipation of business level fluctuations.

In some embodiments, such adjustment can be based on business levels or staffing levels. For example, in some instances performance thresholds could be lengthened in instances where staffing is insufficient, when the quantity of service requests is exceeds some threshold, or based on other factors. In certain embodiments, the thresholds for service requests could be adjusted based on user data for a customer. For example, in some embodiments, the system could set lower or higher service standard for a customer request based on, for example, the customer's loyalty tier status. As such, the system could set a corresponding longer or shorter service threshold time for response to a service request from a user.

In some embodiments, instead of adjusting service standards or thresholds for service requests, the system can set or adjust the employees assigned to the request or the general assignment for an employee. For example, in some embodiments the system could reassign some employees from one area with relatively fewer service requests to another area with a greater number of service requests.

As such, in one or more embodiments, if standards or thresholds for service requests need to be adjusted, then process 2100 proceeds to operation 2124, where service standards can be adjusted, as described above. In various embodiments such adjustments can be made manually, by an employee with appropriate access rights and/or automatically, where the system is configured to make one or more automatic adjustments based on preset client parameters. In one or more embodiments, the process 2100 then proceeds to decision block 2126. Otherwise, if at decision block 2122, no adjustment is needed, the process 2100 skips operation 2124 and proceeds directly decision block 2126.

At decision block 2126, where end user managers require a fee for the requested service, the process 2100 proceeds to operation 2128 where the customer presents payment to a employee end user. In various embodiments, if the company requires payment for storage service, the customer makes payment for storage prior to pick up. The system is updated with payment so attendant is aware prior to item pick up. When the customer retrieves the item they would be required to show their digital ticket and the Attendant activates the pickup button on their smart device indicating the valet process has been completed. Once the Vehicle Pickup Request has been completed the system makes the storage location for both vehicle and keys available again within the system.

In such embodiments, payment can be via access to POS system 2136 to settle payment. In such embodiments the end user can interact with the POS system 2136 via the application 122 to settle any pending charges. In certain embodiments, where applicable, the system can integrate with third party systems. This interface provides ordered items data as necessary to record the transaction activity to end user management's point of sale system. Further, the interface also provides that the charges can subsequently be settled by end user employee personnel at a later point.

Otherwise, the process 2100 proceeds to operation 2130, where the system uses various application logic to assign the request to an employee client device. In various embodiments the system notifies an employee of the assigned service request and indicates the nature of the service request, location of the customer, and other relevant information to the employee. For example, in various embodiments the process 2100 includes sending a text and/or audible notification to the employee via their client device. In such embodiments, at operation 2130, the employee end user can confirm the request using the employee client device.

In various embodiments, at operation 2132, the end user Employee Retrieves Car and Presents Car for Return to Customer. Once the customer request for Vehicle Pickup through the text response link is sent, the pickup is simultaneously sent to the end user employee assigned to retrieve the item in a service queue displayed on the employee's smart device. The queue displays the customer's text number, the storage location, the item description, a “Retrieval” button and a “Completion” button. Both buttons are color-coded based upon clients preset thresholds, the employee who receives the item activates the “Retrieval” button on the smart device thereby assigning that Vehicle Pickup request to them. The end user customer shows the original confirmation text to the employee remitting the retrieved item to confirm the customer's identity. Once the drop off is completed, the employee activates the “Completion” button on the smart device. In certain embodiments, these buttons are color-coded based upon clients preset service time thresholds, as described above.

In various embodiments, by receiving an acknowledgement that the employee has begun to process a service request, the system can begin to track various service metrics, such as for example, the response time of the employee from acceptance until completion of the service request. As such, when the employee completes the service request and sends an acknowledgement of service completion, the system can record the total service time for evaluation/tracking of employee performance.

In various embodiments, at operation 2134, the system can generate service metric data or service reports 2142 from this information. For example, in various embodiments, service metric data includes response times for fulfillment of service requests, comparison of the response times with service standards, customer reviews or ratings, customer complaints generated, and other indicators of employee performance.

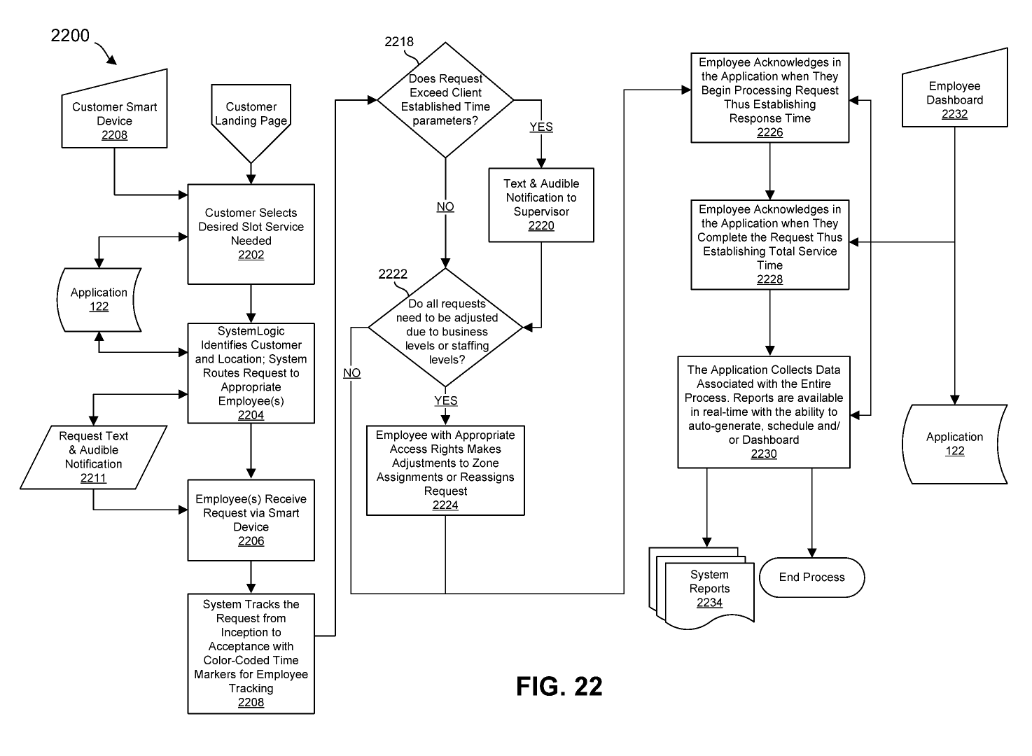

Referring to FIG. 22, a process 2200 flow diagram illustrating the Slot Service process/functionality of the system for service metric data management is depicted, according to one or more embodiments of the disclosure. In one or more embodiments, at operations 2202 and 2204, the process 2200 includes accessing a customer landing page using a customer smart device 2208 and or an Application 122, as described above with reference to FIGS. 1-2. In various embodiments, customer smart device 2208 is a computing node such as computing node 104, 106, 108, described above with reference to FIGS. 1-2.

In various embodiments the customer landing page allows a customer to request a business product or service. For example, in operations 2204, the customer can select a desired slot service, view various client menu selections, and input their selection thereby requesting a service. In such embodiments, the customer landing page displays various menus/selections for a customer and is configured to receive the serve request and forward the request to a server device. As described above, in various embodiments, the customer landing page provides customers with an automated ability to order various slot service items “On Demand” through their smart device utilizing a restricted URL thereby allowing the service to only be accessed within a specific network. In various embodiments access to the service request occurs when the customer logs into designated “free Wi-fi” and is directed to the customer landing page.

In one or more embodiments at operations 2204 and 2206, the system uses various application logic to assign the request to an employee client device. In various embodiments the system notifies an employee of the assigned service request and indicates the nature of the service request, location of the customer, and other relevant information to the employee. For example, in various embodiments the process 2200 includes sending a text and/or audible notification 2211 to the employee via their client device. In such embodiments, the server device can confirm the request using the employee client device.

In addition, in various embodiments, at operation 2208, the system monitors the status of the assigned tasks for each employee from inception to fulfillment of the service request. For example, in various embodiments the system maintains a status of all pending service requests and tracks the time from confirmation of the request to the fulfillment of the request for each employee. In such embodiments, upon order submittal, the process tracks the time it takes for the slot service request to be initiated and completed. In one or more embodiments the service queue display is shown on the employee tablet or client device and service pick-up location device, the item ordered, a “start” and “complete” button. As used herein, and described further below, the term “button” refers to a GUI element that, in various embodiments, is presented to an end user via a display on their client device. In such embodiments, the end user can select or otherwise press the button via user input means such as a keyboard, mouse, touch display, or other suitable input means.

In one or more embodiments, the system is configured to compare the tracked time with preset or known parameters for service standards. In various embodiments the service standards are preset delivery time or service time thresholds that indicate an acceptable time for completion of the service request. For example, the system could be configured to have a service time threshold for response to service request for a slot service request of three minutes, however any amount of time could be set for the service time threshold. As such, in certain embodiments the system tracks the order from inception to completion and compares the tracked time with the three minute threshold.

In certain embodiments, in decision block 2218, if the response time exceeds the threshold, the system notifies a supervisor of the delay at operation 2220. For example, in some embodiments system generated reports detailing runner and location activity are sent to a predetermined group with text alerts or other system alerts and escalations if preset thresholds are exceeded. Otherwise, decision block 2218 proceeds to decision block 2222 without notifying a supervisor.

In various embodiments, the system could use multiple thresholds indicating varying levels of acceptable performance. For example, the system could employ three thresholds corresponding to “excellent” “acceptable” and “unacceptable” performance standards. In certain embodiments, the system uses color-coded time markers to indicate the status of the request to an employee for ease of determining the real time status of the order. For example, in certain embodiments the system could employ a green-colored marker to indicate service that satisfies an “excellent” service threshold, a yellow-colored marker to indicate a service that satisfies an “acceptable” service threshold, and a red-colored marker to indicate a service that satisfies an unacceptable service threshold.

In certain embodiments, at decision block 2222, the system can set or adjust standards or thresholds for service requests. For example, in various embodiments end users with management access can set and change the routing of the service requests, as business and staffing levels dictate, through a dashboard with appropriate level permission access. In such embodiments these dashboard routing changes can be completed in real time or preset in anticipation of business level fluctuations.

In some embodiments, such adjustment can be based on business levels or staffing levels. For example, in some instances performance thresholds could be lengthened in instances where staffing is insufficient, when the quantity of service requests is exceeds some threshold, or based on other factors. In certain embodiments, the thresholds for service requests could be adjusted based on user data for a customer. For example, in some embodiments, the system could set lower or higher service standard for a customer request based on, for example, the customer's loyalty tier status. As such, the system could set a corresponding longer or shorter service threshold time for response to a service request from a user.

In some embodiments, instead of adjusting service standards or thresholds for service requests, the system can set or adjust the employees assigned to the request or the general assignment for an employee. For example, in some embodiments the system could reassign some employees from one area with relatively fewer service requests to another area with a greater number of service requests.

As such, in one or more embodiments, if standards or thresholds for service requests need to be adjusted, then process 2200 proceeds to operation 2224, where service standards can be adjusted, as described above. In various embodiments such adjustments can be made manually, by an employee with appropriate access rights and/or automatically, where the system is configured to make one or more automatic adjustments based on preset client parameters. In one or more embodiments, the process 2200 then proceeds to operation 2226. Otherwise, if at decision block 2222, no adjustment is needed, the process 2200 skips operation 2224 and proceeds directly to operation 2226.

In various embodiments, at operations 2226, and 2228 the process 2200 includes receiving acknowledgement from an assigned employee when they begin processing a service request and when the service request is completed. In various embodiments, by receiving an acknowledgement that the employee has begun to process a service request, the system can begin to track various service metrics, such as for example, the response time of the employee from acceptance until completion of the service request. As such, in operation 2228, when the employee completes the service request and sends an acknowledgement of service completion, the system can record the total service time for evaluation/tracking of employee performance. In certain embodiments the client device for the employee includes a display with “start” and “completed” buttons for indicating the acknowledgement and completion of a service request. In such embodiments, upon receiving the order, the pick-up location begins production of the order. Upon pick-up, the employee delivering the item activates the pickup button on the smart device. Once the item is delivered the employee activates the delivered button on the smart device. In certain embodiments, these buttons are color-coded based upon clients preset service time thresholds, as described above.

In various embodiments, at operation 2230, the system can generate service metric data or service reports 2234 from this information. For example, in various embodiments, service metric data includes response times for fulfillment of service requests, comparison of the response times with service standards, customer reviews or ratings, customer complaints generated, and other indicators of employee performance.

In certain embodiments, for at least operations 2224, 2226, 2228, and 2230, an employee interacts with the system via an employee device that provides access to application 112 via an employee dashboard 2232 or other interface that allows for input to the system.

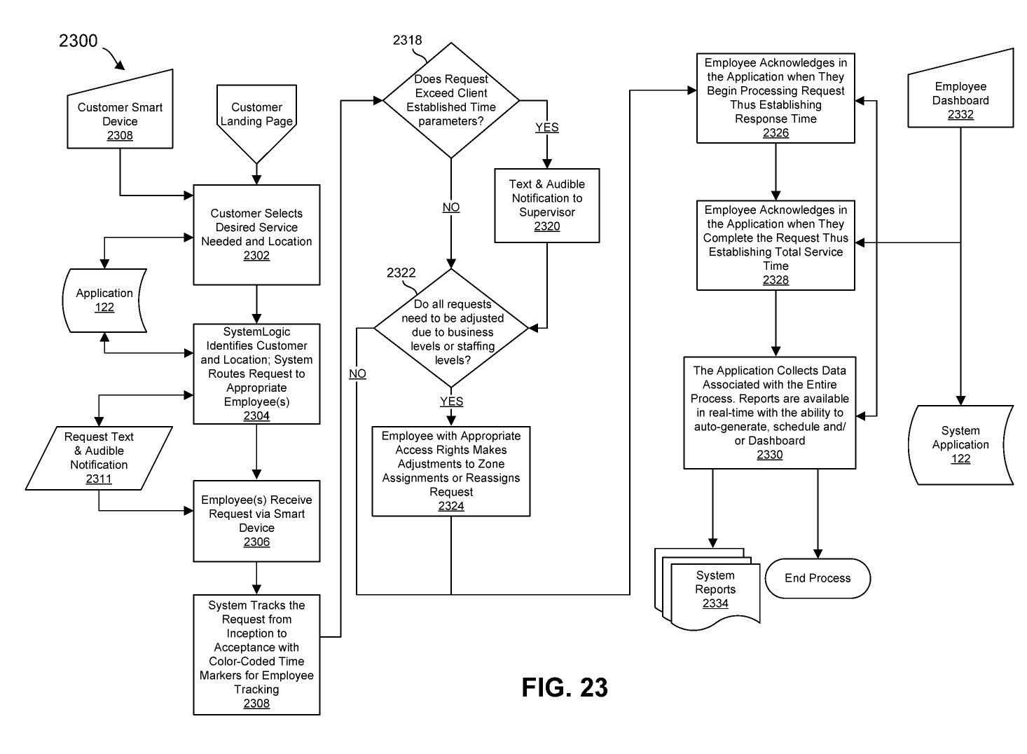

Referring to FIG. 23, a process 2300 flow diagram illustrating the Help-Service process/functionality of the system for service metric data management is depicted, according to one or more embodiments of the disclosure. In one or more embodiments, at operations 2302 and 2304, the process 2300 includes accessing a customer landing page using a customer smart device 2308 and or an Application 122, as described above with reference to FIGS. 1-2. In various embodiments, customer smart device 2308 is a computing node such as computing node 104, 106, 108, described above with reference to FIGS. 1-2.

In various embodiments the customer landing page allows a customer to request a business product or service. For example, in operations 2304, the customer can select a desired the Service/Help Request, view various client menu selections, and input their selection thereby requesting a service, or enter a specific request in a text-box. In such embodiments, the customer landing page displays various menus/selections for a customer and is configured to receive the serve request and forward the request to a server device. As described above, in various embodiments, the customer landing page provides customers with an automated ability to order various Help-Desk or Help-Service items “On Demand” through their smart device utilizing a restricted URL thereby allowing the service to only be accessed within a specific network. In various embodiments access to the service request occurs when the customer logs into designated “free Wi-Fi” and is directed to the customer landing page.

In one or more embodiments at operations 2304 and 2306, the system uses various application logic to assign the request to an employee client device. In various embodiments the system notifies an employee of the assigned service request and indicates the nature of the service request, location of the customer, and other relevant information to the employee. For example, in various embodiments the process 2300 includes sending a text and/or audible notification 2311 to the employee via their client device. In such embodiments, the server device can confirm the request using the employee client device.

In addition, in various embodiments, at operation 2308, the system monitors the status of the assigned tasks for each employee from inception to fulfillment of the service request. For example, in various embodiments the system maintains a status of all pending service requests and tracks the time from confirmation of the request to the fulfillment of the request for each employee. In such embodiments, upon order submittal, the process tracks the time it takes for the requested service request to be initiated and completed. In one or more embodiments the service queue display is shown on the employee tablet or client device and service pick-up location device, the item ordered, a “start” and “complete” button.

In one or more embodiments, the system is configured to compare the tracked time with preset or known parameters for service standards. In various embodiments the service standards are preset delivery time or service time thresholds that indicate an acceptable time for completion of the service request. For example, the system could be configured to have a service time threshold for response to service request for a help-desk service request of three minutes, however any amount of time could be set for the service time threshold. As such, in certain embodiments the system tracks the order from inception to completion and compares the tracked time with the three minute threshold.

In certain embodiments, in decision block 2318, if the response time exceeds the threshold, the system notifies a supervisor of the delay at operation 2320. For example, in some embodiments system generated reports detailing runner and location activity are sent to a predetermined group with text alerts or other system alerts and escalations if preset thresholds are exceeded. Otherwise, decision block 2318 proceeds to decision block 2322 without notifying a supervisor.

In various embodiments, the system could use multiple thresholds indicating varying levels of acceptable performance. For example, the system could employ three thresholds corresponding to “excellent” “acceptable” and “unacceptable” performance standards. In certain embodiments, the system uses color-coded time markers to indicate the status of the request to an employee for ease of determining the real time status of the order. For example, in certain embodiments the system could employ a green-colored marker to indicate service that satisfies an “excellent” service threshold, a yellow-colored marker to indicate a service that satisfies an “acceptable” service threshold, and a red-colored marker to indicate a service that satisfies an unacceptable service threshold.

In certain embodiments, at decision block 2322, the system can set or adjust standards or thresholds for service requests. For example, in various embodiments end users with management access can set and change the routing of the service requests, as business and staffing levels dictate, through a dashboard with appropriate level permission access. In such embodiments these dashboard routing changes can be completed in real time or preset in anticipation of business level fluctuations.

In some embodiments, such adjustment can be based on business levels or staffing levels. For example, in some instances performance thresholds could be lengthened in instances where staffing is insufficient, when the quantity of service requests is exceeds some threshold, or based on other factors. In certain embodiments, the thresholds for service requests could be adjusted based on user data for a customer. For example, in some embodiments, the system could set lower or higher service standard for a customer request based on, for example, the customer's loyalty tier status. As such, the system could set a corresponding longer or shorter service threshold time for response to a service request from a user.

In some embodiments, instead of adjusting service standards or thresholds for service requests, the system can set or adjust the employees assigned to the request or the general assignment for an employee. For example, in some embodiments the system could reassign some employees from one area with relatively fewer service requests to another area with a greater number of service requests.

As such, in one or more embodiments, if standards or thresholds for service requests need to be adjusted, then process 2300 proceeds to operation 2324, where service standards can be adjusted, as described above. In various embodiments such adjustments can be made manually, by an employee with appropriate access rights and/or automatically, where the system is configured to make one or more automatic adjustments based on preset client parameters. In one or more embodiments, the process 2300 then proceeds to operation 2326. Otherwise, if at decision block 2322, no adjustment is needed, the process 2300 skips operation 2324 and proceeds directly to operation 2326.

In various embodiments, at operations 2326, and 2328 the process 2330 includes receiving acknowledgement from an assigned employee when they begin processing a service request and when the service request is completed. In various embodiments, by receiving an acknowledgement that the employee has begun to process a service request, the system can begin to track various service metrics, such as for example, the response time of the employee from acceptance until completion of the service request. As such, in operation 2328, when the employee completes the service request and sends an acknowledgement of service completion, the system can record the total service time for evaluation/tracking of employee performance. In certain embodiments the client device for the employee includes a display with “start” and “completed” buttons for indicating the acknowledgement and completion of a service request. In such embodiments, upon receiving the order, the pick-up location begins production of the order. Upon pick-up, the employee delivering the item activates the pickup button on the smart device. Once the item is delivered the employee activates the delivered button on the smart device. In certain embodiments, these buttons are color-coded based upon clients preset service time thresholds, as described above.

In various embodiments, at operation 2330, the system can generate service metric data or service reports 2334 from this information. For example, in various embodiments, service metric data includes response times for fulfillment of service requests, comparison of the response times with service standards, customer reviews or ratings, customer complaints generated, and other indicators of employee performance.

In certain embodiments, for at least operations 2324, 2326, 2328, and 2330, an employee interacts with the system via an employee device that provides access to application 112 via an employee dashboard 2332 or other interface that allows for input to the system.

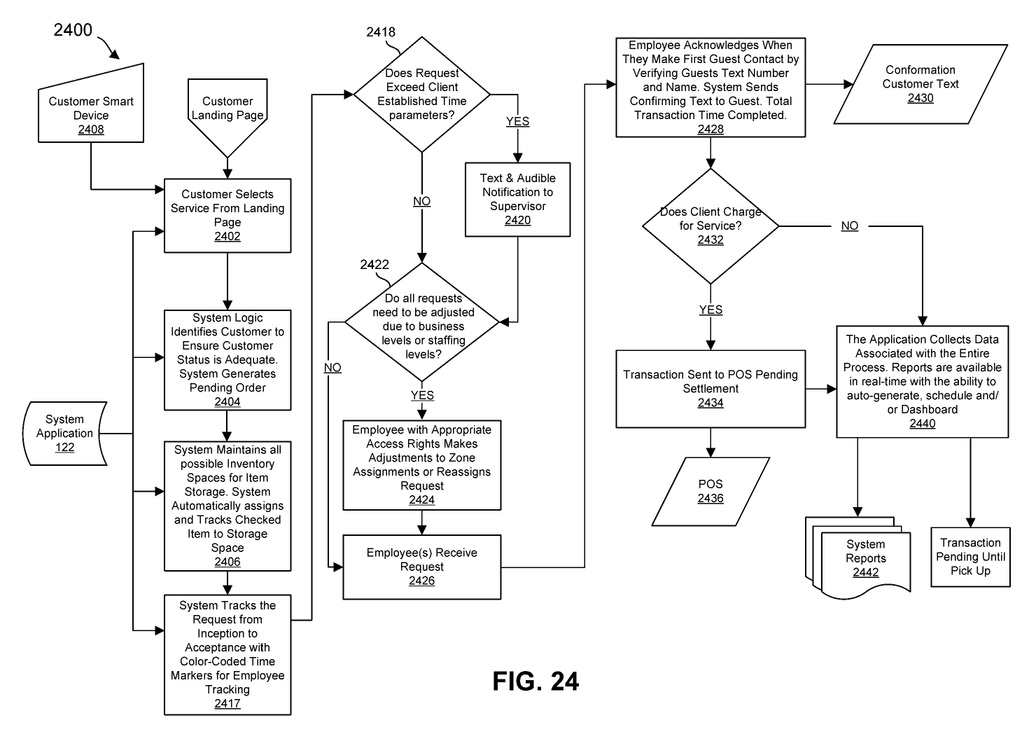

Referring to FIG. 24, depicts a process 2400 flow diagram illustrating the Checked Item Drop Off process/functionality of the system for service metric data management, according to one or more embodiments of the disclosure.

In one or more embodiments, at operation 2402, the process 2400 includes accessing a customer landing page using a customer smart device 2408 and/or an Application 122, as described above with reference to FIGS. 1-2. In various embodiments, customer smart device 2008 is a computing node such as computing node 104, 106, 108, described above with reference to FIGS. 1-2.

In various embodiments the customer landing page allows a customer to request a business product or service. For example, in operation 2402, the customer can review various valet services and input their selection using the smart device 2408 and application 122. In such embodiments, the customer landing page displays various menus/selections for a customer and is configured to receive and process a user selected service request. For example, as described above, in various embodiments, the customer landing page provides customers with an automated ability to initiate an item drop-off process through a smart device utilizing a restricted URL thereby allowing the customer landing page to only be accessed within a specific network. In various embodiments access to these services occurs when the customer logs into designated “free Wi-Fi” and is directed to the customer landing page. In various embodiments, once the valet service request has been accepted by the process the guest originating the request receives an automated text listing a unique “e-ticket” number, short item description and a link to be used for requesting item pickup. Described further, below, in various embodiments, once the drop-off service request is submitted the request is simultaneously routed to employee(s) who will receive the item to a service queue displaying on the employee's smart device.

In one or more embodiments at operation 2404 the system uses various application logic to identify the end user, determine an end user status, and generate service orders. For example, in various embodiments the item Drop-Off Service Request functionality identifies users based on their unique full cell phone number and then access a description of item being dropped off from drop down lists of common descriptions or enter into a text box any description not listed. In some embodiments the system can additional identify the end user based on their status as a customer, employee, manager, department, time of day, their location and other relevant system parameters.

In various embodiments, referring to operation 2406, the system is configured to maintain a database of all possible item storage spots. For example, in various embodiments the system maintains an inventory of all storage spots where items are stored. In such embodiments the system automatically assigns the item to an appropriate storage location. In such embodiments feedback from customer end users and employee end users will automatically update the status of the possible storage sports. For example, in certain embodiments, once an item drop off request is submitted the system automatically categorizes the storage space as “vacant”. In some embodiments, the vacant status of the storage space first awaits confirmation or is listed as “pending” until an employee end user indicates to the system that the storage space is indeed vacant. As a result, in various embodiments the system records maintains an automated listing of vacant and occupied storage spaces.

In various embodiments, at operation 2417, upon valet service request submittal, the process 2400 tracks the time it takes for the end user employee to make first contact with the customer till completion of the task. The service queue display shown on the employee smart device lists item Drop Off request including “e-ticket” number, assigned location, “Drop Off” and “Completed” buttons. The end user employee is given the item by the customer, and attaches an automated ticket that displays the customer cell number, assigned storage location and brief description of the item.

In various embodiments, the system assigns valet service tasks to employee end users upon customer initiation of a service request. For example, as described above, the system can notify various employee end users of “item drop-off request”, indicating an item location and the service request within an employee task queue displayed on the employee's smart device.

In one or more embodiments the system tracks and monitors information from inception, or vehicle drop off, to, completion, with color-coded time markers or other similar alert methods indicated to the employees so they can easily determine the real-time status of the information. The management end user can preset parameters to send out automated text messages or other system alerts when the information exceeds predetermined thresholds. The process then utilizes logic to route observations, service times and other metrics to specific management to report in both real-time and post-fact basis.

In one or more embodiments, the system is configured to compare the tracked time with preset or known parameters for service standards. In various embodiments the service standards are preset delivery time or service time thresholds that indicate an acceptable time for completion of the service request. For example, the system could be configured to have a service time threshold for response to service request for item drop-off service request of 15 minutes, however any amount of time could be set for the service time threshold. As such, in certain embodiments the system tracks the order from inception to completion and compares the tracked time with the 15 minute threshold. In certain embodiments, in decision block 2418, if the response time exceeds the threshold, the system notifies a supervisor of the delay at operation 2420. For example, in some embodiments system generated reports detailing runner and location activity are sent to a predetermined group with text alerts or other system alerts and escalations if preset thresholds are exceeded. Otherwise, decision block 2418 proceeds to decision block 2422 without notifying a supervisor.

In various embodiments, the system could use multiple thresholds indicating varying levels of acceptable performance. For example, the system could employ three thresholds corresponding to “excellent” “acceptable” and “unacceptable” performance standards. In certain embodiments, the system uses color-coded time markers to indicate the status of the request to an employee for ease of determining the real time status of the order. For example, in certain embodiments the system could employ a green-colored marker to indicate service that satisfies an “excellent” service threshold, a yellow-colored marker to indicate a service that satisfies an “acceptable” service threshold, and a red-colored marker to indicate a service that satisfies an unacceptable service threshold.

In certain embodiments, at decision block 2422, the system can set or adjust standards or thresholds for service requests. For example, in various embodiments end users with management access can set and change the routing of the service requests, as business and staffing levels dictate, through a dashboard with appropriate level permission access. In such embodiments these dashboard routing changes can be completed in real time or preset in anticipation of business level fluctuations.

In some embodiments, such adjustment can be based on business levels or staffing levels. For example, in some instances performance thresholds could be lengthened in instances where staffing is insufficient, when the quantity of service requests is exceeds some threshold, or based on other factors. In certain embodiments, the thresholds for service requests could be adjusted based on user data for a customer. For example, in some embodiments, the system could set lower or higher service standard for a customer request based on, for example, the customer's loyalty tier status. As such, the system could set a corresponding longer or shorter service threshold time for response to a service request from a user.

In some embodiments, instead of adjusting service standards or thresholds for service requests, the system can set or adjust the employees assigned to the request or the general assignment for an employee. For example, in some embodiments the system could reassign some employees from one area with relatively fewer service requests to another area with a greater number of service requests.

As such, in one or more embodiments, if standards or thresholds for service requests need to be adjusted, then process 2400 proceeds to operation 2424, where service standards can be adjusted, as described above. In various embodiments such adjustments can be made manually, by an employee with appropriate access rights and/or automatically, where the system is configured to make one or more automatic adjustments based on preset client parameters. In one or more embodiments, the process 2400 then proceeds to operation 2426.

Otherwise, if at decision block 2422, no adjustment is needed, the process 2400 skips operation 2424 and proceeds directly to operation 2426.

In one or more embodiments at operation 2426, the system uses various application logic to assign the request to an employee client device. In various embodiments the system notifies an employee of the assigned service request and indicates the nature of the service request, location of the customer, and other relevant information to the employee. For example, in various embodiments the process 2400 includes sending a text and/or audible notification to the employee via their client device.

In such embodiments, at operation 2428, the employee end user can confirm the request using the employee client device. In certain embodiments operation 2428 includes receiving acknowledgement from an assigned employee when they begin processing a service request and when the service request is completed. In various embodiments, by receiving an acknowledgement that the employee has begun to process a service request, the system can begin to track various service metrics, such as for example, the response time of the employee from acceptance until completion of the service request. As such, when the employee completes the service request and sends an acknowledgement of service completion, the system can record the total service time for evaluation/tracking of employee performance. In certain embodiments the client device for the employee includes a display with “start” and “completed” buttons for indicating the acknowledgement and completion of a service request. In certain embodiments, these buttons are color-coded based upon clients preset service time thresholds, as described above. In various embodiments, the employee end user acknowledges when they begin processing a service request by making first guest contact. In such embodiments, the employee end user can make First Guest Contact by Verifying Guests Text Number and Name. In some embodiments, at operation 2430, the system sends a confirmation text to the customer end user. When the employee acknowledges the service request. In various embodiments, once the task is completed, the employee can indicate the completion of the task using their client device. In various embodiments the system notes the total transaction time.

At decision block 2432, where end user managers require a fee for the requested service, once submitted the drop off is sent to a POS system 2436 to settle payment. In such embodiments the end user can interact with the POS system 2436 via the application 122 to settle any pending charges. In certain embodiments, where applicable, the system can integrate with third party systems. This interface provides ordered items data as necessary to record the transaction activity to end user management's point of sale system. Further, the interface also provides that the charges can subsequently be settled by end user employee personnel at a later point.

Otherwise, in various embodiments, at operation 2440, the system can generate service metric data or service reports 2442 from this information. For example, in various embodiments, service metric data includes response times for fulfillment of service requests, comparison of the response times with service standards, customer reviews or ratings, customer complaints generated, and other indicators of employee performance.

In various embodiments, the transaction remains pending within the system until the item is picked up or the pick-up process is initiated by a customer.

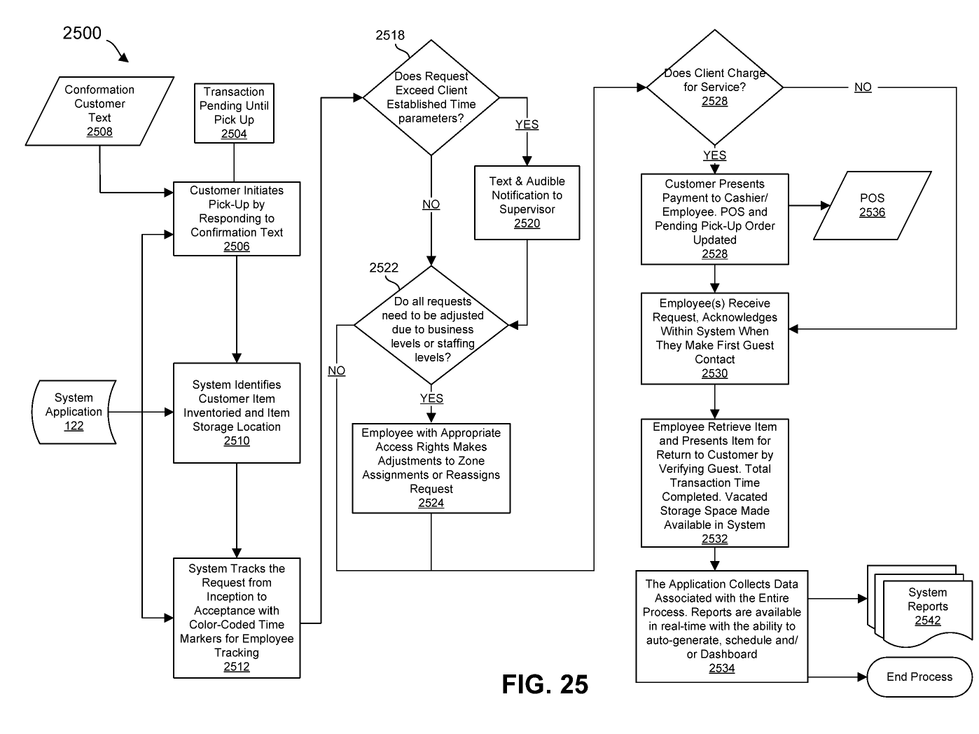

Referring to FIG. 25, a process 2500 flow diagram illustrating the Checked Item Pick-Up process/functionality of the system for service metric data management is depicted, according to one or more embodiments of the disclosure. In various embodiments, at operation 2504 the transaction remains pending within the system until the item is picked up or the pick-up process is initiated by a customer. In such embodiments, the customer can initiate an item pick-up service by responding to a confirmation text 2508 that is sent to the customer when the item is initially stored. However, in certain embodiments the customer can initiate pick up using system application 122, such as through their client device, as described above. In various embodiments the Item Pick-up process provides customers with an automated ability to pick up items previously dropped off through their smart device by utilizing a response link in the drop off “e-ticket” text previously sent to the guest's smart device at drop off.

In one or more embodiments at operation 2510 the system uses various application logic to identify the end user, determine an end user status, and generate service orders. For example, in various embodiments the system is configured to maintain a database of all possible item storage spots. For example, in various embodiments the system maintains an inventory of all storage spots and associated item storage spaces where items are stored. In such embodiments the system automatically identifies the location of the item based on the stored data associated with the identified user.

In various embodiments, at operation 2512, upon valet service request submittal, the process 2500 tracks the time it takes for the end user employee to make first contact with the customer till completion of the task. The service queue display shown on the employee smart device lists Valet pick-up request including “e-ticket” number, assigned location, “start” and “completed” buttons. In various embodiments, the system assigns valet service tasks to employee end users upon customer initiation of a service request. For example, as described above, the system can notify various employee end users of “item storage request”, indicating a item location and the service request within an employee task queue displayed on the employee's smart device.

In one or more embodiments the system tracks and monitors information from inception, or item drop off, to, completion, or item pickup with color-coded time markers or other similar alert methods indicated to the employees so they can easily determine the real-time status of the information. The management end user can preset parameters to send out automated text messages or other system alerts when the information exceeds predetermined thresholds. The process then utilizes logic to route observations, service times and other metrics to specific management to report in both real-time and post-fact basis.

In one or more embodiments, the system is configured to compare the tracked time with preset or known parameters for service standards. In various embodiments the service standards are preset delivery time or service time thresholds that indicate an acceptable time for completion of the service request. For example, the system could be configured to have a service time threshold for response to service request for item service request of 15 minutes, however any amount of time could be set for the service time threshold. As such, in certain embodiments the system tracks the order from inception to completion and compares the tracked time with the 15 minute threshold. In certain embodiments, in decision block 2518, if the response time exceeds the threshold, the system notifies a supervisor of the delay at operation 2520. For example, in some embodiments system generated reports detailing runner and location activity are sent to a predetermined group with text alerts or other system alerts and escalations if preset thresholds are exceeded. Otherwise, decision block 2518 proceeds to decision block 2522 without notifying a supervisor.

In various embodiments, the system could use multiple thresholds indicating varying levels of acceptable performance. For example, the system could employ three thresholds corresponding to “excellent” “acceptable” and “unacceptable” performance standards. In certain embodiments, the system uses color-coded time markers to indicate the status of the request to an employee for ease of determining the real time status of the order. For example, in certain embodiments the system could employ a green-colored marker to indicate service that satisfies an “excellent” service threshold, a yellow-colored marker to indicate a service that satisfies an “acceptable” service threshold, and a red-colored marker to indicate a service that satisfies an unacceptable service threshold.

In certain embodiments, at decision block 2522, the system can set or adjust standards or thresholds for service requests. For example, in various embodiments end users with management access can set and change the routing of the service requests, as business and staffing levels dictate, through a dashboard with appropriate level permission access. In such embodiments these dashboard routing changes can be completed in real time or preset in anticipation of business level fluctuations.

In some embodiments, such adjustment can be based on business levels or staffing levels. For example, in some instances performance thresholds could be lengthened in instances where staffing is insufficient, when the quantity of service requests is exceeds some threshold, or based on other factors. In certain embodiments, the thresholds for service requests could be adjusted based on user data for a customer. For example, in some embodiments, the system could set lower or higher service standard for a customer request based on, for example, the customer's loyalty tier status. As such, the system could set a corresponding longer or shorter service threshold time for response to a service request from a user.

In some embodiments, instead of adjusting service standards or thresholds for service requests, the system can set or adjust the employees assigned to the request or the general assignment for an employee. For example, in some embodiments the system could reassign some employees from one area with relatively fewer service requests to another area with a greater number of service requests.

As such, in one or more embodiments, if standards or thresholds for service requests need to be adjusted, then process 2500 proceeds to operation 2524, where service standards can be adjusted, as described above. In various embodiments such adjustments can be made manually, by an employee with appropriate access rights and/or automatically, where the system is configured to make one or more automatic adjustments based on preset client parameters. In one or more embodiments, the process 2500 then proceeds to decision block 2526. Otherwise, if at decision block 2522, no adjustment is needed, the process 2500 skips operation 2524 and proceeds directly decision block 2526.

At decision block 2526, where end user managers require a fee for the requested service, the process 2500 proceeds to operation 2528 where the customer presents payment to a employee end user. In various embodiments, if the company requires payment for storage service, the customer makes payment for storage prior to pick up. The system is updated with payment so attendant is aware prior to item pick up. When the customer retrieves the item they would be required to show their digital ticket and the Attendant activates the pickup button on their smart device indicating the item pick-up process has been completed. Once the item Pickup Request has been completed the system makes the storage location available again within the system.

In such embodiments, payment can be via access to POS system 2536 to settle payment. In such embodiments the end user can interact with the POS system 2536 via the application 122 to settle any pending charges. In certain embodiments, where applicable, the system can integrate with third party systems. This interface provides ordered items data as necessary to record the transaction activity to end user management's point of sale system. Further, the interface also provides that the charges can subsequently be settled by end user employee personnel at a later point.

Otherwise, the process 2500 proceeds to operation 2530, where the system uses various application logic to assign the request to an employee client device. In various embodiments the system notifies an employee of the assigned service request and indicates the nature of the service request, location of the customer, and other relevant information to the employee. For example, in various embodiments the process 2500 includes sending a text and/or audible notification to the employee via their client device. In such embodiments, at operation 2530, the employee end user can confirm the request using the employee client device.

In various embodiments, at operation 2532, the end user Employee Retrieves and Presents the stored item for Return to Customer. Once the customer request for item Pickup through the text response link is sent, the pickup is simultaneously sent to the end user employee assigned to retrieve the item in a service queue displayed on the employee's smart device. The queue displays the customer's text or phone number, the storage location, the item description, a “Retrieval” button and a “Completion” button. Both buttons are color-coded based upon clients preset thresholds, the employee who receives the item activates the “Retrieval” button on the smart device thereby assigning that item Pickup request to them. The end user customer shows the original confirmation text to the employee remitting the retrieved item to confirm the customer's identity. Once the drop off is completed, the employee activates the “Completion” button on the smart device. In certain embodiments, these buttons are color-coded based upon clients preset service time thresholds, as described above.

In various embodiments, by receiving an acknowledgement that the employee has begun to process a service request, the system can begin to track various service metrics, such as for example, the response time of the employee from acceptance until completion of the service request. As such, when the employee completes the service request and sends an acknowledgement of service completion, the system can record the total service time for evaluation/tracking of employee performance.

In various embodiments, at operation 2134, the system can generate service metric data or service reports 2142 from this information. For example, in various embodiments, service metric data includes response times for fulfillment of service requests, comparison of the response times with service standards, customer reviews or ratings, customer complaints generated, and other indicators of employee performance.

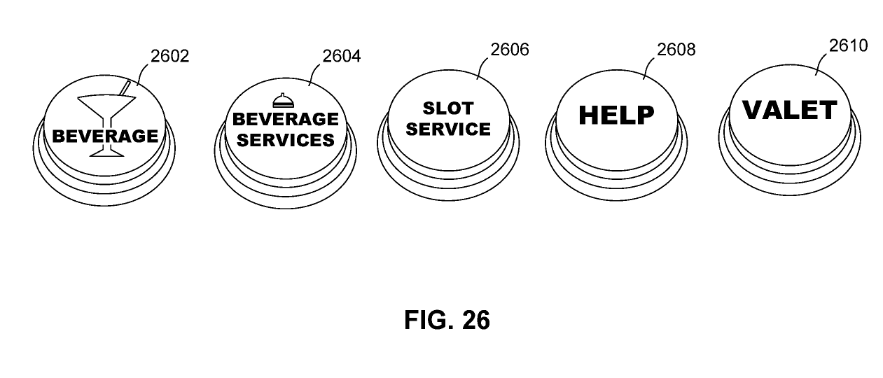

FIG. 26 depicts a variety or service request buttons 2602, 2604, 2606, 2608, 2610 for a system for service metric data management, according to one or more embodiments. As described herein, in various embodiments the system can include a variety of different buttons in a GUI for selection by a customer to indicate a type of service requested. In various embodiments the buttons include a beverage button 2602, a hotel guest services button 2604, a room service button, a food button, a slot service button 2606, a general help button 2608, and a valet button 2610. While these buttons are depicted in FIG. 26, in certain embodiments, the system could include or fewer buttons, depending on the available services to the customer.

In various embodiments the beverage button provides customers with an automated ability to order beverages “On Demand” through their smart device. In various embodiments, the button is utilized via a restricted URL, such that the Beverage Button can only be accessed within a specific network or walled garden network. For example, to access the Beverage Button the customer logs into designated “free Wi-fi” and is directed to a landing page. From the landing page the customer can access a beverage menu, identify their location and order their beverage. Once submitted the beverage order is simultaneously sent to a service queue displaying on the drink runner's smart tablet and the service bar's computer terminal.

Upon order submittal the process tracks the time it takes for the runner to pick up and deliver the order. The service queue display shown on the runner(s) tablet and service bar's terminal lists the location, beverage ordered, a pickup up and delivered button. The pickup and delivered button are color-coded based upon clients preset thresholds.

In various embodiments, upon receiving the order the service bar begins production of the order. Upon pickup, the drink runner activates the pickup button on their tablet. Once the beverage is delivered the drink runner activates the delivered button on their tablet. The process then starts over again. As described, in various embodiments management has the ability to set and change the routing of the beverage order through a dashboard with level permission access as business and staffing levels dictate. These dashboard routing changes can be completed in real time or preset in anticipation of business level fluctuations. In one or more embodiments system generated reports detailing runner and location activity are sent to a predetermined group with text alerts and escalations if preset thresholds are exceeded.

The hotel guest services button can allow the performance of multiple Guest Services tasks or allow requests from a customer smart phone, tablet or laptop. To access the Hotel Guest Services Button a hotel guest would select a designated network on a smart device and then be directed to a landing page. In certain embodiments, from the landing page the guest can access the Hotel Guest Services Button where they can choose to “Browse the Web”, “Request Housekeeping Services”, “Order Room Service”, “View their Room Charges” or “View Room Charges and Check Out”.

To browse the web, in various embodiments, in exchange for accessing free Wi-Fi, the guest would be required to take a short 2-3 question survey. Once the survey is submitted they would be directed to the internet.

To request services from housekeeping, if the guest chooses to request services from Housekeeping they would list their room number and then access a drop down list of common requests or have the ability to enter into a text box any request not listed. Once submitted their request is automatically routed to the assigned Housekeeper and Supervisor and displayed to a service queue on their respective smart devices. The service queue displays location of the room, request made, an acknowledge button and a completed button.

Upon receiving the request the Housekeeper activated the acknowledge button which sends an automated text to the guest letting them know that an employee is on the way. Once the request has been completed the Housekeeper activated the completed button.

System generated reports detailing housekeeper response times and reasons for requests are sent to a predetermined group with text alerts and escalations if preset thresholds are exceeded.

To request services from Room Service, if the guest chooses to request services from Room Service they would list their room number and then access a series of drop down lists of common menu items. Once submitted their request is automatically routed to the assigned Room Service Server and Supervisor and displayed to a service queue on their respective smart devices. The service queue displays location of the room, menu item(s) request made, an acknowledge button and a completed button.

Upon receiving the request the Room Service Server activates the acknowledge button which sends an automated text to the guest letting them know that an employee is on the way. Once the request has been completed the Room Service Server activates the completed button.

System generated reports detailing room service response times and menu items requested are sent to a predetermined group with text alerts and escalations if preset thresholds are exceeded.

Regarding viewing Room Charges and/or Check Out, in various embodiments, through the Hotel Guest Services Button the guest also has the ability to view their room charges and, if accepting that any additional charges be billed to the credit card on file, check out.

Slot guests can request service by accessing the Slot Service Button through their smart device. The process creates a direct line of communication between the slot player and the slot attendant assigned to the area the guest is playing in. To access the Slot Service Button a slot player would select a designated network on a smart device and then be directed to a landing page. From the landing page if the guest chooses to request slot service they would access a drop down list of common requests or have the ability to enter into a text box any request not listed.

Once submitted their request is automatically routed to the assigned Slot Attendant and Supervisor and displayed to a service queue on their respective smart devices. In various embodiments, the service queue displays location of the guest, request made, a response button and a completed button. Upon arriving at the guest's location the Slot Attendant activates the response button. Once the request has been completed the Attendant activates the completed button.

Management has the ability to set and change the routing of the service requests through a dashboard with level permission access as business and staffing levels dictate. These dashboard routing changes can be completed in real time or preset in anticipation of business level fluctuations. System generated reports detailing slot response times and reasons for requests are sent to a predetermined group with text alerts and escalations if preset thresholds are exceeded.

Using the General Help Button, customers can request service/help by accessing the Property Help Button through their smart device. To access the Help Button a customer would select a designated network on a smart device and then be directed to a landing page. From the landing page, the guest can access the Help Button where they would indicate their location.

After designating their location the customer would then choose their request from a list of the most common reasons a customer would need assistance or they could enter their request into a text box.

Once submitted a text is automatically sent to the employee(s) assigned the particular area/task. A return text is then generated from the assigned employee letting the customer know that an employee is the way and with an estimated response time.

System generated reports detailing housekeeper response times and reasons for requests are sent to a predetermined group with text alerts and escalations if preset thresholds are exceeded.

Customers can initiate the Valet process by accessing the Valet Button through their smart device. For example, upon driving up to the Valet drop off area a customer would access the Valet Button by selecting a designated network on a smart device and then be directed to a landing page. From the landing page the guest can access the Valet Button where they would enter their cell phone number, select a brief description of their vehicle from a list and submit.

Upon submitting the customer would receive an automated text displaying their digital valet ticket with unique identification number, cell number and a “Pickup” link. Once submitted the Valet Drop Off request is sent to a service queue on all Valet Attendant's smart devices and on the computer terminal at the Valet Cashier (if applicable). The service queue would display customer cell number, brief car description, drop off button and pick up button.

The Attendant who conducts the handoff of the vehicle is given the keys by the customer attaches the customer cell number to the keys. After the vehicle is parked the Attendant places the keys in a secure key box in the key spot predetermined and communicated by the process. When the customer is ready to leave they would open the text with the valet ticket and activate the link. This notifies the Valet Attendants that the vehicle is ready to be picked up and the space in the key box where the keys are located. An Attendant then retrieves the vehicle and is waiting in the valet pick up area.

When the customer retrieves the vehicle they would be required to show their digital valet ticket and the Attendant activates the pickup button on their smart device indicating the valet process has been completed. System generated reports detailing Attendant response times and overall volume are sent to a predetermined group with text alerts and escalations if preset thresholds are exceeded.

One or more embodiments of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A system for managing service metric data at a venue comprising:
a server device and a plurality of client devices communicatively connected with the server device via a restricted access wireless network that is associated with the venue, wherein at least one of the client devices is associated with a customer and at least one of the client devices is associated with an employee, the server device and the plurality of client devices each including a processor and a computer readable storage medium, the computer readable storage medium of the server device includes instructions executable by the processor of the server device to cause the server device to:
receive a service request from the at least one client device associated with the customer;
assign the service request to the employee;
transmit the service request to the at least one client device associated with the employee;
receive an acknowledgement from the at least one client device associated with the employee when the service request is complete;
calculate a response time for the service request;
generate service metric data, including at least a comparison of the response time to a predetermined service threshold time.

2. The system for managing service metric data at a venue of claim 1, wherein the restricted access wireless network is a WiFi network.

3. The system for managing service metric data at a venue of claim 1, wherein the plurality of client devices are handheld mobile devices.

4. The system for managing service metric data at a venue of claim 1, wherein the plurality of client devices transmit location data to the server device.

5. The system for managing service metric data at a venue of claim 1, wherein the service request is assigned to the employee using a first in first out algorithm.

6. The system for managing service metric data at a venue of claim 1, wherein the service request is assigned to the employee according to a predetermined customer profile.

7. The system for managing service metric data at a venue of claim 6, wherein the predetermined customer profile is based on a customer loyalty tier status.

8. The system for managing service metric data at a venue of claim 1, wherein the client device associated with the customer is owned by the customer.

9. The system for managing service metric data at a venue of claim 1, further comprising:
determining that the generated service metric data indicates that the response time exceeds the predetermined service threshold time; and
in response, notifying the employee of the service metric data via the client device associated with the employee.

10. A system for managing service metric data at a venue comprising:
a server device and a plurality of client devices communicatively connected with the server device via a restricted access wireless network that is associated with the venue, wherein at least one of the client devices is associated with and owned by a customer and at least one of the client devices is associated with an employee, the server device and the plurality of client devices each including a processor and a computer readable storage medium, the computer readable storage medium of the server device includes instructions executable by the processor of the server device to cause the server device to:
receive a food item request from the at least one client device associated with the customer;
receive location data from the at least one client device associated with the customer;
assign the food item request to the employee;
transmit the food item request and the location data to the at least one client device associated with the employee;
receive an acknowledgement from the at least one client device associated with the employee when the food item request is delivered to the customer;
calculate a response time for the food item request;
generate service metric data, including at least a comparison of the response time to a predetermined service threshold time.

11. The system for managing service metric data at a venue of claim 10, wherein the server device transmits a menu to the at least one client device associated with the customer.

12. The system for managing service metric data at a venue of claim 10, wherein the at least one client device associated with the customer transmits updated location data to the server device prior to delivery of the food item.

13. The system for managing service metric data at a venue of claim 10, wherein the restricted access wireless network is a WiFi network.

14. The system for managing service metric data at a venue of claim 10, wherein the plurality of client devices are handheld mobile devices.

15. The system for managing service metric data at a venue of claim 10, wherein the service request is assigned to the employee using a first in first out algorithm.

16. The system for managing service metric data at a venue of claim 10, wherein the service request is assigned to the employee according to a predetermined customer profile.

17. The system for managing service metric data at a venue of claim 16, wherein the predetermined customer profile is based on a customer loyalty tier status.

18. The system for managing service metric data at a venue of claim 10, further comprising:
determining that the generated service metric data indicates that the response time exceeds the predetermined service threshold time; and
in response, notifying the employee of the service metric data via the client device associated with the employee.

19. A computer program product for managing service metric data at a venue using a system including a server device and a plurality of client devices communicatively connected with the server device via a restricted access wireless network that is associated with the venue, wherein at least one of the client devices is associated with a customer and at least one of the client devices is associated with an employee, the computer program product comprising:
a computer readable storage medium having program instructions embodied therewith, wherein the computer readable storage medium is not a transitory signal per se, the program instructions executable by a processor, the program instructions comprising:
program instruction means to receive a service request from the at least one client device associated with the customer;
program instruction means to assign the service request to the employee;
program instruction means to transmit the service request to the at least one client device associated with the employee;
program instruction means to receive an acknowledgement from the at least one client device associated with the employee when the service request is complete;
program instruction means to calculate a response time for the service request;
program instruction means to generate service metric data, including at least a comparison of the response time to a predetermined service threshold time.

20. The computer program product of claim 19, further comprising:
program instruction means to determine that the generated service metric data indicates that the response time exceeds the predetermined service threshold time; and
program instructions means to, in response, notify the employee of the service metric data via the client device associated with the employee.
